(19) United States
(12) Patent Application Publication
(10) Pub. No.: US 2010/0207727 A1
(43) Pub. Date: Aug. 19, 2010

(54) Information processing apparatus, method, and program

(75) Inventors: Yukiko Kanekiyo, Tokyo (JP); Masahiro Matsushita, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/658,097

(22) Filed: Feb. 2, 2010

(30) Foreign Application Priority Data
Feb. 9, 2009 (JP) P2009-027389

(51) Int. Cl. G06F 7/04

(52) U.S. Cl. 340/5.82

(57) ABSTRACT

An information processing apparatus includes: a biometric information acquirer configured to acquire a user's biometric information; an instructions receiver configured to receive instructions from the user; and an associating unit configured to associate the biometric information with information obtained on the basis of the instructions.

### CROSS-REFERENCE TO RELATED APPLICATION

The present application claims priority from Japanese Patent Application No. JP JP 2009-027389 filed in the Japanese Patent Office on Feb. 9, 2009, the entire content of which is incorporated herein by reference.

### BACKGROUND OF THE INVENTION

1. Field of the Invention

The present invention relates to an information processing apparatus, method, and program. More specifically, the present invention relates to an information processing apparatus, method, and program enabling easier usage of information.

2. Description of the Related Art

The digitization of information is advancing in recent years, and digital equipment handling digital information, such as digital still cameras and digital video cameras, are becoming more prevalent. In many cases, such digital equipment is shared by a plurality of users, such as a family.

When digital equipment is shared by multiple people, it might be difficult to sort each user's created or other data if such data is mixed together. Thus, a user might not easily obtain his or her desired data. Particularly, in the case of equipment with a small chassis, such as a digital still camera or digital video camera, it is difficult to provide an large-scale input interface enabling complex user operations. In many cases, a simple input interface such as buttons or a touch panel are provided. When the user operates such a simple input interface in such cases, actions such as data sorting or data searching often become troublesome.

Consequently, methods have been conceived wherein, for example, fingerprint authentication is conducted at power-on, and pictures shot (i.e., photographed, recorded, or otherwise acquired) thereafter are then saved to a folder generated for each set of feature points from the fingerprint authentication. (See, for example, Japanese Unexamined Patent Application Publication Nos. 2004-171488, 2002-281439 (U.S. Pat. No. 7,154,536), and 2002-218389.)

In addition, a method has been conceived wherein shooter information and shooting conditions are assigned to shot data. (See, for example, Japanese Unexamined Patent Application Publication No. 2006-326187.)

### SUMMARY OF THE INVENTION

However, the methods disclosed in JP-A-2004-171488, JP-A-2002-281439, and JP-A-2002-218389 above merely sort generated data into per-user folders using user fingerprint or other information, without controlling content usage and similar factors. For example, it might be difficult to modify settings such as content usage restrictions. In addition, application to information other than content is difficult. For example, the above methods are difficult to realize for information that is not available for sorting into folders, such as device settings information and command control methods. Moreover, even assuming such information is sorted, it might be difficult to improve the user-friendliness of such information.

Meanwhile, the method disclosed in JP-A-2006-326187 presumes that shooting will take place with a user logged in to the device using a user account and password. If, for example, another person performs shooting operations after a first user has logged in, correct information about the actual device operator might not be assigned to the shot data.

Given such circumstances, it is desirable to provide a configuration whereby a user's biometric information and instructions are received, and information obtained by the input instructions is associated with the user's biometric information as control information for that information. In so doing, that information can be more easily used.

An information processing apparatus in accordance with an embodiment of the present invention includes: acquiring means for acquiring a user's biometric information; receiving means for receiving instructions from the user; and associating means for associating the biometric information with information obtained on the basis of the instructions.

The information processing apparatus may also be configured such that the information is settings information for the information processing apparatus, and generated on the basis of the instructions received by the receiving means.

The information processing apparatus may also be configured such that the information is user data for the user, and registered in the information processing apparatus on the basis of the instructions received by the receiving means.

The information processing apparatus may also be configured such that settings information for the information processing apparatus is associated with the user data.

The information processing apparatus may additionally include duplicating means for duplicating another user's user data, and changing the other user's identification information that is contained in the user data to the user's identification information, on the basis of the instructions received by the receiving means. The associating means then replaces identification information for the other user's biometric information contained in the user data with identification information for the user's biometric information.

The information processing apparatus may also be configured such that the information is command execution availability settings for a command specified by the instructions received by the receiving means.

The information processing apparatus may also be configured such that the information is content generated on the basis of the instructions received by the receiving means.

The information processing apparatus may also be configured such that the associating means associates the biometric information with the content as usage permission settings for the content.

The information processing apparatus may also be configured such that the associating means associates the biometric information with the content as information indicating the creator of the content.

The information processing apparatus may also be configured such that the acquiring means is provided at a place on the chassis of the information processing apparatus that is easily touched by the user's fingers, and wherein the acquiring means acquires biometric information in the form of the user's fingerprint.

An information processing method in accordance with another embodiment of the present invention includes the steps of: acquiring a user's biometric information; receiving instructions from the user; and associating the acquired biometric information with information obtained on the basis of the received instructions.

A program in accordance with another embodiment of the present invention causes a computer to execute an information processing method. The method includes steps of: acquiring a user's biometric information; receiving instructions from the user; and associating the acquired biometric information with information obtained on the basis of the received instructions.

In an embodiment of the present invention, a user's biometric information is acquired, a user's instructions are received, and information obtained on the basis of the received instructions is associated with the acquired biometric information.

According to an embodiment of the present invention, information can be processed. More particularly, information can be used more easily.

### BRIEF DESCRIPTION OF THE DRAWINGS

FIG. 1 is a block diagram illustrating the primary configuration of a shooting apparatus to which an embodiment of the present invention has been applied;

FIG. 2 is a diagram for explaining sensor installation positions;

FIG. 3A is a diagram for explaining sensor installation positions;

FIG. 3B is a diagram for explaining sensor installation positions;

FIG. 4 is a block diagram illustrating the primary configuration of a fingerprint detector in accordance with an embodiment of the present invention;

FIG. 5 is a flowchart for explaining a data generation process;

FIG. 6 is a block diagram illustrating the primary configuration of a controller in accordance with an embodiment of the present invention;

FIG. 7 is a flowchart for explaining the flow of a shooting process in accordance with an embodiment of the present invention;

FIG. 8 is a schematic diagram for explaining table information indicating relationships between image files and shooters;

FIG. 9 is a flowchart for explaining the flow of an image display process in accordance with an embodiment of the present invention;

FIG. 10 is a schematic diagram for explaining the display of shot images in accordance with an embodiment of the present invention;

FIG. 11 is a schematic diagram for explaining the display of shot images in accordance with an embodiment of the present invention;

FIG. 12 is a block diagram illustrating the primary configuration of a controller in accordance with another embodiment of the present invention;

FIG. 13 is a flowchart explaining the flow of a view-authorized person configuration process in accordance with an embodiment of the present invention;

FIG. 14 is a schematic diagram for explaining table information indicating relationships between image files and view-authorized persons;

FIG. 15 is a block diagram illustrating the primary configuration of a controller in accordance with another embodiment of the present invention;

FIG. 16 is a flowchart for explaining the flow of a settings data generation process in accordance with an embodiment of the present invention;

FIG. 17 is a schematic diagram for explaining table information indicating relationships between shooters and shooting settings;

FIG. 18 is a flowchart for explaining the flow of a shooting process in accordance with another embodiment of the present invention;

FIG. 19 is a schematic diagram for explaining the display of shooting settings in accordance with an embodiment of the present invention;

FIG. 20 is a schematic diagram for explaining the display of shooting settings in accordance with an embodiment of the present invention;

FIG. 21 is a block diagram illustrating the primary configuration of a controller in accordance with another embodiment of the present invention;

FIG. 22 is a flowchart for explaining the flow of a user data generation process in accordance with an embodiment of the present invention;

FIG. 23 is a schematic diagram for explaining table information indicating relationships between user identification information and biometric data;

FIG. 24 is a flowchart for explaining the flow of a user data deletion process in accordance with an embodiment of the present invention;

FIG. 25 is a schematic diagram for explaining how shooting settings table information and user data table information are associated in accordance with an embodiment of the present invention;

FIG. 26 is a schematic diagram for explaining how shooting settings table information and user data table information are associated in accordance with another embodiment of the present invention;

FIG. 27 is a flowchart for explaining the flow of a user data duplication process in accordance with an embodiment of the present invention;

FIG. 28 is a schematic diagram for explaining how shooting settings table information and user data table information are associated in accordance with another embodiment of the present invention;

FIG. 29 is a block diagram illustrating the primary configuration of a controller in accordance with another embodiment of the present invention;

FIG. 30 is a flowchart for explaining the flow of a user data duplication process in accordance with another embodiment of the present invention;

FIG. 31 is a schematic diagram for explaining how shooting settings table information and user data table information are associated in accordance with another embodiment of the present invention;

FIG. 32 is a block diagram illustrating the primary configuration of a controller in accordance with another embodiment of the present invention;

FIG. 33 is a schematic diagram for explaining table information indicating relationships between commands and use-authorized users;

FIG. 34 is a flowchart for explaining the flow of a command execution control process in accordance with an embodiment of the present invention;

FIG. 35 is a diagram for explaining sensor installation positions;

FIG. 36 is a block diagram illustrating the primary configurations of controllers in accordance with an embodiment of the present invention;

FIG. 37 is a flowchart for explaining the flow of a command execution process in accordance with an embodiment of the present invention;

FIG. 38 is a block diagram illustrating the primary configuration of a controller in accordance with another embodiment of the present invention; and

FIG. 39 is a flowchart for explaining the flow of a command execution process in accordance with an embodiment of the present invention.

### DESCRIPTION OF THE PREFERRED EMBODIMENTS

Hereinafter, embodiments of the present invention will be described. The description will proceed as follows.

1. First Embodiment (method of assigning biometric data of shooters to shot images)

2. Second Embodiment (method of assigning biometric data of view-authorized persons to shot images)

3. Third Embodiment (method of assigning biometric data to settings data)

4. Fourth Embodiment (method of assigning biometric data to user data)

5. Fifth Embodiment (method of associating settings data with user data)

6. Sixth Embodiment (method of associating biometric data with command controls)

7. Seventh Embodiment (method of associating biometric data with command controls of other apparatus)

### 1. First Embodiment

### [Overview of Shooting Apparatus]

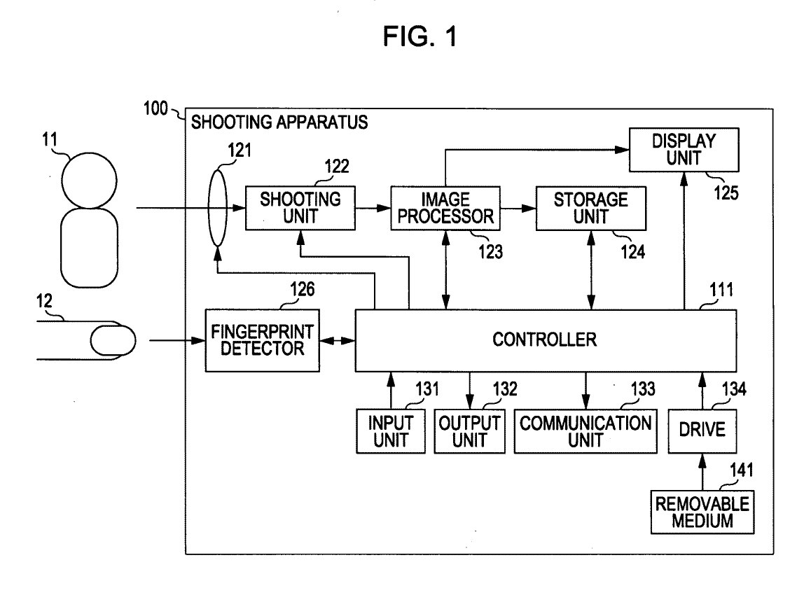

FIG. 1 is a block diagram illustrating the primary configuration of a shooting apparatus to which an embodiment of the present invention has been applied.

The shooting apparatus 100 shoots a subject 11, converts an image of the subject (i.e., a shot image) into electronic data, and then performs actions such as displaying and storing the obtained image data. The shooting apparatus 100 may be an electronic device such as a digital still camera or camcorder, for example. Hereinafter, embodiments of the present invention will be described using this shooting apparatus 100 as an example of such an electronic device, but it should be appreciated that an embodiment of the present invention may be applied to any type of apparatus that processes digital data. Consequently, an embodiment of the present invention may be applied to an arbitrary electronic device other than the shooting apparatus 100, such as a music player, a sound recorder, a television, a DVD player, a hard disk recorder, an editing apparatus, a mobile phone, a video game console, a personal computer, a server, medical equipment, measuring equipment, or control equipment, for example.

As shown in FIG. 1, the shooting apparatus 100 includes a controller 111, optics 121, a shooting unit 122, an image processor 123, a storage unit 124, a display unit 125, a fingerprint detector 126, an input unit 131, an output unit 132, a communication unit 133, and a drive 134.

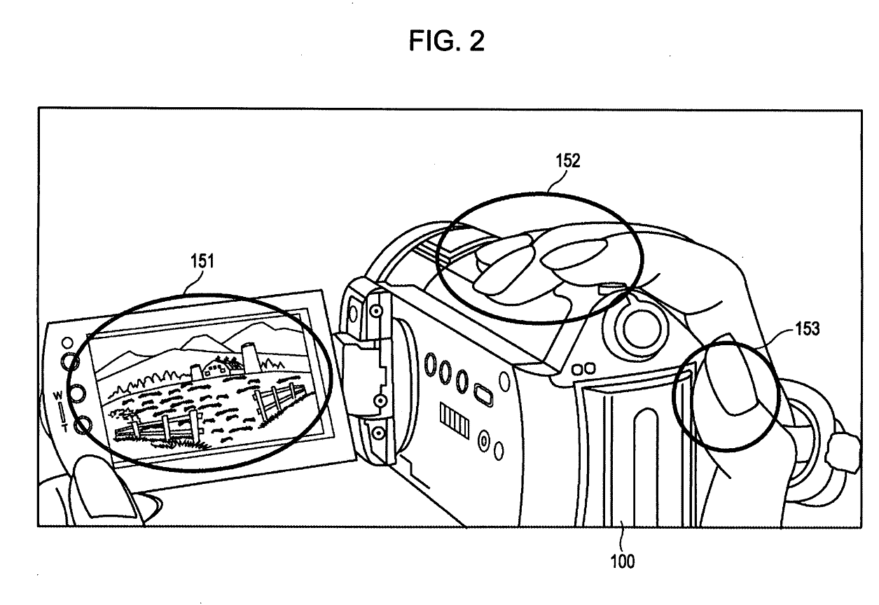

The arrows shown in FIG. 1 indicate primary information transfer directions and control relationships. Each block is also capable of sending and receiving signals (i.e., data) and performing controls with respect to other blocks, as appropriate, in ways other than that shown in FIG. 1. FIG. 2 and subsequent drawings are also similar.

The optics 121 include optical elements such as a lens, an aperture, and a mechanical shutter. The optics 121 adjust focal length and exposure settings. When shooting, the optics 121 allow incident light external to the shooting apparatus 100 to pass through and be supplied to the shooting unit 122. The shooting unit 122 includes photoelectric elements such as a CCD (Charge-Coupled Device) or CMOS (Complementary Metal-Oxide Semiconductor) sensor, for example. Using such photoelectric elements, the shooting unit 122 converts the incident light supplied via the optics 121 (i.e., the shot image) into electronic data, and generates image data for the shot image. The shooting unit 122 supplies the generated image data to the image processor 123.

The image processor 123 subjects the image data supplied by the shooting unit 122 to predetermined image processing such as image quality adjustment and size conversion, for example. The image processor 123 supplies the processed image data to the storage unit 124 and causes the image data to be stored, for example. The image processor 123 may also supply the processed image data to the display unit 125 and cause the image to be displayed, for example. Additionally, the image processor 123 may supply the processed image data to the controller 111 for use in processes executed in the controller 111, for example.

The storage unit 124 is a storage medium that stores image data, and herein stores information such as the image data supplied by the image processor 123 and the controller 111. In addition, the storage unit 124 also supplies stored image data to the controller 111 or other components as appropriate. The storage unit 124 includes an arbitrary storage medium, which may be a magnetic recording medium such as a flexible disk, a tape device, or hard disk, an optical disc such as a CD (Compact Disc) or DVD (Digital Versatile Disc), or semiconductor memory such as SRAM (Static Random Access Memory) or DRAM (Dynamic Random Access Memory), for example.

The storage medium herein may also be a removable medium such as a CD or DVD (i.e., a removable medium capable of storing information) capable of being removably loaded into the storage unit 124. In this case, the storage unit 124 includes a removable medium capable of storing information as well as a drive or other means into which the removable medium is loaded. The drive is a device able to write or read information to or from a loaded removable medium.

The storage unit 124 may be any means able to store image data, and may be configured to store information in a device other than those given above.

The display unit 125 displays images of image data supplied from the image processor 123 and the controller 111, while also displaying a GUI (Graphical User Interface) or other elements. The display unit 125 includes an arbitrary display, such as an LCD, PDP (Plasma Display Panel), organic EL display (Organic Electro-Luminescence Display), or CRT (Cathode Ray Tube), for example. The display unit 125 may be any means able to display images, and may be configured to display information on a device other than those given above. In addition, a transparent touch panel for receiving user instructions or other information may also be stacked onto or otherwise combined with the screen of the display unit 125.

The fingerprint detector 126 includes a sensor that detects biometric data in the form of fingerprints. This sensor is provided at a predetermined position on the chassis of the shooting apparatus 100, and reads a fingerprint of the user operating the shooting apparatus 100. The fingerprint detector 126 converts the fingerprint of the user thus read into electronic data, which is detected as biometric data. The fingerprint detector 126 supplies the result to the controller 111.

Hereinafter, embodiments of the present invention are described using fingerprints as an example of biometric data. However, it should be appreciated that the biometric data may be any information that can be used to identify individual users. For example, vein patterns in the palm or retina, palm shape, the iris, face shape, voiceprints, handwriting, DNA (Deoxyribonucleic acid), or any other such information may be used. However, the authentication technology is widely available for the case of fingerprint authentication, and thus reliable authentication (i.e., detection processing) can be easily realized in an inexpensive and compact form.

The controller 111 includes components such as a CPU (Central Processing Unit), ROM (Read-Only Memory), and RAM (Random Access Memory), and conducts various processes for controlling the operation of the shooting apparatus 100. The controller 111 realizes the various functions of the shooting apparatus 100 by loading and executing programs or data read from the ROM into the RAM.

For example, by controlling the components from the optics 121 to the display unit 125, the controller 111 may cause a subject to be shot, and then cause the resulting image data to be displayed or stored. As another example, the controller 111 may associate biometric data (i.e., a fingerprint) detected by the fingerprint detector 126 with generated or updated data on the basis of user instructions input via the input unit 131. As another example, the controller 111 may use biometric data (i.e., a fingerprint) detected by the fingerprint detector 126 as a basis for controlling processes executed as a result of user instructions input via the input unit 131. Such control processes will be later described in detail.

Herein, the programs or data loaded into the RAM may be read out from the storage unit 124, or read out from a removable medium 141 loaded into the drive 134.

The input unit 131 is a user interface operated by the user to receive instructions and then supply those instructions to the controller 111. The input unit 131 includes elements such as buttons, knobs, switches, and a touch panel, for example. Obviously, the input unit 131 may also be configured to include input devices other than the above.

The output unit 132 outputs information supplied by the controller 111 to apparatus external to the shooting apparatus 100. The output unit 132 may include one or more speakers for outputting audio, a monitor other than the display unit 125 for displaying information such as images and text, or one or more output ports for outputting electric signals (i.e., information). Obviously, the output unit 132 may also be configured to include output devices other than the above.

The communication unit 133 establishes a wired or wireless communication link with the communication unit of an apparatus other than the shooting apparatus 100, on the basis of a predetermined standard. The communication unit 133 then provides information supplied by the controller 111 to the other apparatus, or supplies the controller 111 with information acquired from the other apparatus. The communication unit 133 communicates on the basis of an arbitrary standard, such as Ethernet™, IEEE 802.11 (Institute of Electrical and Electronic Engineers 802.11), Bluetooth, USB (Universal Serial Bus), IEEE 1394, or HDMI (High-Definition Multimedia Interface), for example.

The drive 134 drives a removable medium 141 loaded thereinto, such as a magnetic disk, an optical disc, a magneto-optical disc, or semiconductor memory. The drive 134 reads programs or data from the loaded removable medium 141, and supplies the read information to the controller 111. Herein, the drive 134 may be a device that differs from the shooting apparatus 100, and configured to be suitably connected to the shooting apparatus 100 when the shooting apparatus 100 reads information stored in the removable medium 141.

It should be appreciated that each component may be configured to include elements other than those described above. In addition, the shooting apparatus 100 may obviously be configured to include elements other than those described above.

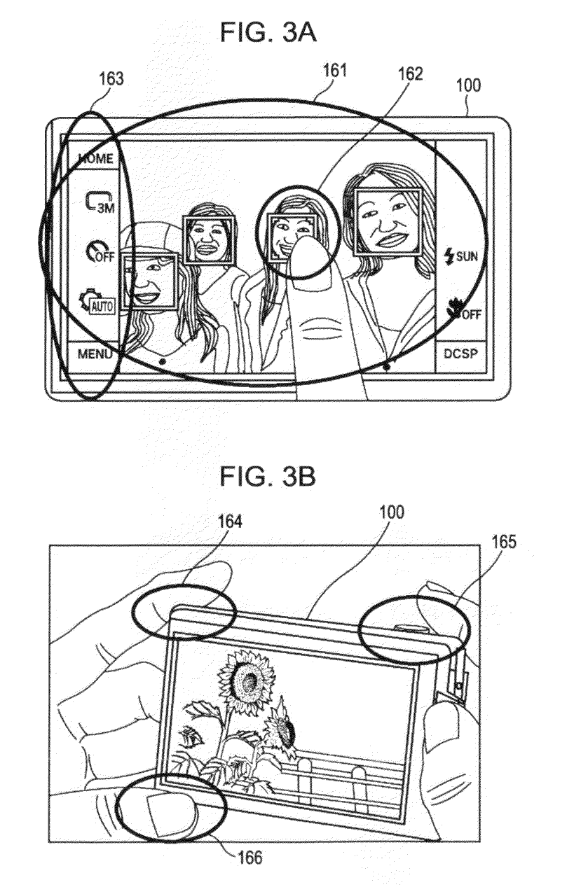

Next, the position of the sensor provided in the fingerprint detector 126 will be described. FIGS. 2 to 3B are diagrams for explaining sensor installation positions. In the case where a display is provided on the chassis of the shooting apparatus 100 as shown by way of example in FIG. 2, a fingerprint detection function may be provided in the touch panel installed on the display screen, and configured to detect a fingerprint of the user operating the touch panel (ellipse 151). As another example, a sensor for fingerprint detection may also be provided at a position that is assumed to correspond to the position of a respective finger when the user's hand grips the chassis of the shooting apparatus 100, with the sensor configured to detect a fingerprint of the hand (fingers) gripping the chassis (ellipses 152 and 153).

Additionally, in the case where a touch panel is stacked with a display provided on the chassis of the shooting apparatus 100 as described earlier, the sensor may be configured such that detection is conducted over the entire screen of the display, or just in a partial region. The detection region may be set to be the entire screen of the display provided in the shooting apparatus 100, like the ellipse 161 shown by way of example in FIG. 3A. Alternatively, the detection region may be set to be just a portion where it is determined that a face appears in a displayed shot image, like the ellipse 162 shown by way of example in FIG. 3A. Furthermore, the detection region may be set to be the portion where a GUI is displayed instead of an image, like the ellipse 163 shown by way of example in FIG. 3A.

In addition, a sensor may also be provided on a switch or predetermined button such as a release button, like the ellipse 165 shown in FIG. 3B. As another example, a plurality of sensors may be provided at multiple positions on the chassis of the shooting apparatus 100 where the user's fingers are likely to touch when shooting, like the ellipses 164 to 166 shown in FIG. 3B.

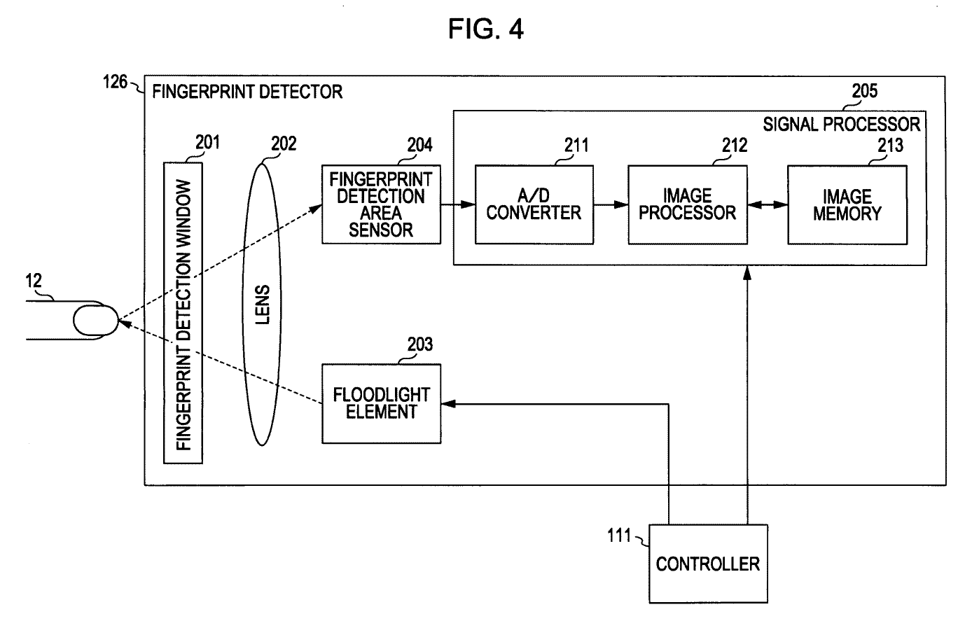

Next, the fingerprint detector 126 will be described in detail. FIG. 4 is a block diagram illustrating the primary configuration of a fingerprint detector 126 in accordance with an embodiment of the present invention. As shown in FIG. 4, the fingerprint detector 126 includes a fingerprint detection window 201, a lens 202, a floodlight element 203, a fingerprint detection area sensor 204, and a signal processor 205.

The fingerprint detection window 201 is the plane where fingerprint detection occurs, and is transparent to both light emitted by the floodlight element 203 as well the reflected light that has reflected off the user's finger 12. In other words, a fingerprint is detected for the finger 12 held up to the fingerprint detection window 201. The lens 202 adjusts the focal length and position of the light used for fingerprint detection.

The floodlight element 203 is controlled by the controller 111 to generate and emit the light used for fingerprint detection. Light emitted by the floodlight element 203 illuminates the finger 12 via the lens 202 and the fingerprint detection window 201, and is partially reflected. This reflected light is supplied to the fingerprint detection area sensor 204 via the fingerprint detection window 201 and the lens 202.

By photoelectrically converting the reflected light, the fingerprint detection area sensor 204 converts the fingerprint pattern of the finger 12 into an electrical signal. The fingerprint detection area sensor 204 supplies the electrical signal to the signal processor 205.

The signal processor 205 is controlled by the controller 111 to digitize the electrical signal supplied by the fingerprint detection area sensor 204 as the detection result, and thereby generates biometric data. The signal processor 205 includes an A/D converter 211, an image processor 212, and image memory 213.

The A/D converter 211 digitizes the analog electrical signal supplied by the fingerprint detection area sensor 204, and supplies the resulting digital data to the image processor 212. In other words, this digital data is biometric data containing the fingerprint pattern of the finger 12. The image processor 212 processes the digital data supplied by the A/D converter 211 in order to make the fingerprint pattern clearer, for example. While processing, the image processor 212 also stores the digital data as appropriate in the image memory 213, a predetermined storage unit realized by means of SRAM, for example. The image processor 212 then supplies the processed digital data to the controller 111, for example.

Herein, the fingerprint detector 126 may obviously be configured to include elements other than those described above.

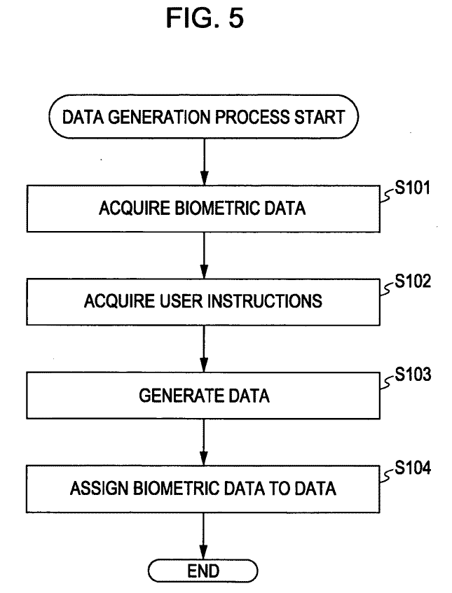

Next, the flow of a data generation process in accordance with an embodiment of the present invention will be described with reference to the flowchart shown in FIG. 5. In this process, the controller 111 associates biometric data (i.e., a fingerprint) detected by the fingerprint detector 126 with generated or updated data on the basis of user instructions input via the input unit 131.

The user operates the input unit 131 to input user instructions, while also causing a fingerprint of his or her finger 12 to be detected in the fingerprint detector 126. At this point, the user may operate the input unit 131 after causing his or her fingerprint to be detected, or the fingerprint detector 126 may be configured to detect a fingerprint of the user's finger 12 as he or she operates the input unit 131.

Once the data generation process is initiated, in step S101 the controller 111 controls the fingerprint detector 126 to acquire biometric data (i.e., a fingerprint) of the user. In step S102, the controller 111 acquires the user instructions input via the input unit 131 as described above. In step S103, the controller 111 generates data following the user instructions acquired in step S102. In step S104, the controller 111 assigns the biometric data acquired in step S101 to the data generated in step S103. It should be appreciated that such assignment may include not only appending the biometric data or information indicating the biometric data to the data, but also generating information that associates the biometric data with the data.

When the processing in step S104 ends, the data generation process is terminated.

Herein, the biometric data may also be assigned when updating data. In this case, the controller 111 updates existing data in step S103, rather than generating data.

In this way, by assigning a user's biometric data to data that has been generated or updated according to user instructions, the controller 111 is able to use that biometric data to control data management and execution. In other words, the controller 111 is easily able to control data management and execution in accordance with a user's wishes. In so doing, the user is able to more easily make use of information.

Hereinafter, specific examples will be described.

### [Shooter Identification]

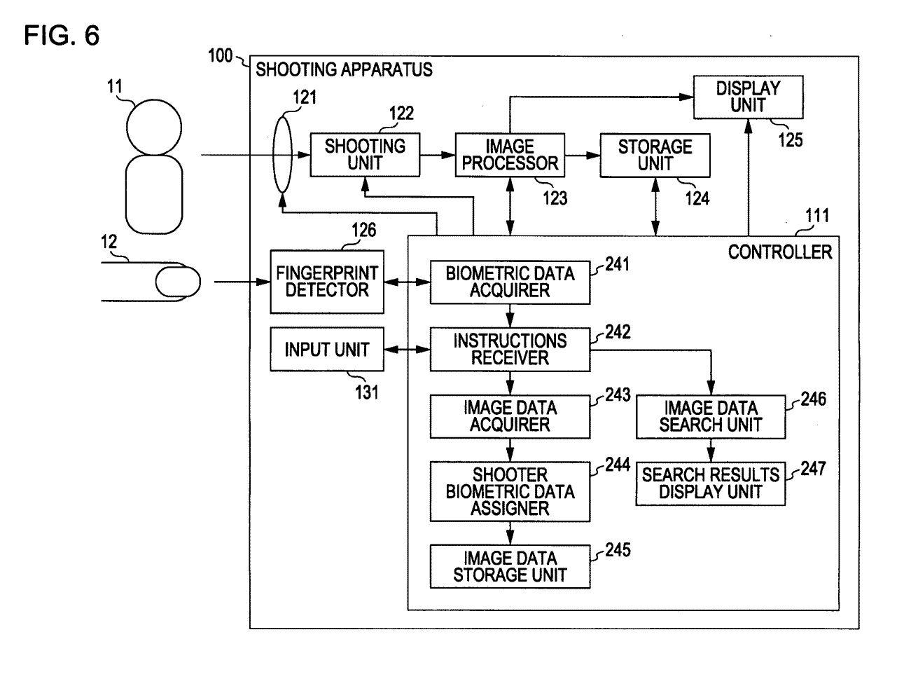

The shooting apparatus 100 is able to, for example, assign the biometric data of a shooter to shot image data (i.e., content) obtained by shooting a subject, with the biometric data acting as information that indicates the creator. Also, the shooting apparatus 100 is able to, for example, use such biometric data to control the display of image data. FIG. 6 is a block diagram illustrating the primary configuration of a controller 111 in accordance with an embodiment of the present invention for this case.

The controller 111 includes the following function blocks: a biometric data acquirer 241, an instructions receiver 242, an image data acquirer 243, a shooter biometric data assigner 244, an image data storage unit 245, an image data search unit 246, and a search results display unit 247.

The functions indicated by these function blocks are realized in the controller 111 as a result of a CPU loading and executing programs and data read from ROM into RAM, for example.

The biometric data acquirer 241 controls the fingerprint detector 126 and causes the finger 12 of the user (i.e., the shooter) to be detected, and thereby acquires the user's biometric data. The instructions receiver 242 receives and acquires user instructions input via the input unit 131. When, for example, the user instructions are instructions to shoot a subject, the instructions receiver 242 supplies the user instructions to the image data acquirer 243. When the user instructions are instructions to display image data, the instructions receiver 242 supplies the user instructions to the image data search unit 246.

On the basis of user instructions received by the instructions receiver 242, the image data acquirer 243 controls the components from the optics 121 to the display unit 125 to cause a subject 11 to be shot, and thereby acquires image data for the shot image.

The shooter biometric data assigner 244 takes image data (i.e., a shot image) acquired by the image data acquirer 243, and assigns to it information indicating the creator of that image data. More specifically, the shooter biometric data assigner 244 assigns (i.e., appends or associates) the biometric data of the user (i.e., the shooter, or in other words, the creator of the image data) whose biometric data was acquired by the biometric data acquirer 241. The image data storage unit 245 supplies the image data with assigned user biometric data to the storage unit 124, and causes the data to be stored therein.

On the basis of user instructions received by the instructions receiver 242, the image data search unit 246 uses the user biometric data acquired by the biometric data acquirer 241 to conduct a search for images to present to the user from among the images expressed by the image data stored in the storage unit 124. The search results display unit 247 causes the results of the search by the image data search unit 246 to be displayed on the display unit 125.

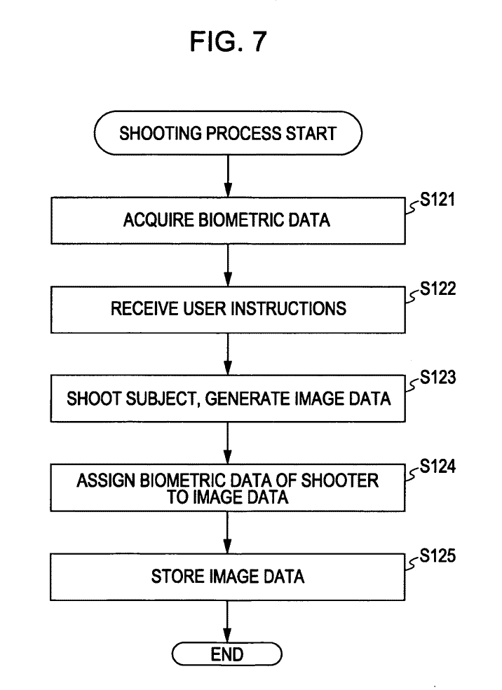

The flow of a shooting process whereby a subject is shot in accordance with an embodiment of the present invention will now be described with reference to the flowchart shown in FIG. 7.

Once the shooting process is initiated, in step S121 the biometric data acquirer 241 acquires the biometric data of the user (i.e., the shooter). Operating the shooting apparatus 100, the user (shooter) causes the fingerprint detector 126 to detect a fingerprint of his or her finger 12, points the shooting apparatus 100 at the subject 11, and issues instructions to shoot the subject by performing an action such as depressing a release button. In step S122, the instructions receiver 242 receives the user instructions.

In step S123, the image data acquirer 243 shoots the subject and generates image data. In step S124, the shooter biometric data assigner 244 assigns the biometric data acquired in step S121 to the image data as information indicating the shooter (i.e., creator) of that image data. For example, the shooter biometric data assigner 244 may append the biometric data of the shooter (creator) to the image data (or its metadata). The biometric data may be configured to be appended as an entry in the RAW data, or to the user-specifying region of an existing format such as Exif (Exchangeable Image File Format). An independent format enabling the appending of biometric data may also be prepared.

In step S125, the image data storage unit 245 causes the image data with assigned biometric data to be stored in the storage unit 124.

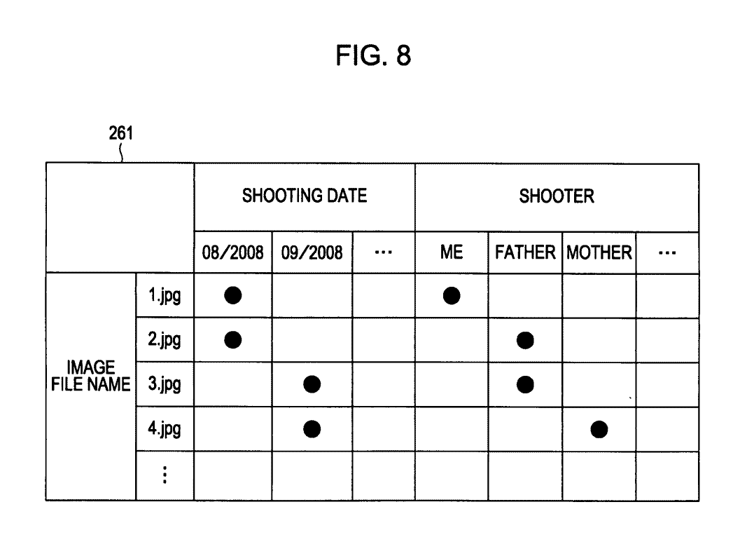

Herein, the biometric data may also be associated by means of table information like that shown by way of example in FIG. 8. The table information 261 shown in FIG. 8 is profile information for managing image data. The controller 111 manages image data stored in the storage unit 124 by generating (or updating) management information for respective image data as shown in the table information 261.

In other words, in this case, the image data storage unit 245 causes both image data and table information 261 to be stored in the storage unit 124 in step S125.

In the table information 261, individual image data is associated with a shooting date indicating the time when the image data was generated, as well as shooter information indicating the user who performed the shooting. Herein, the biometric data is registered in association with a separate user (i.e., shooter) names (IDs). Obviously, the biometric data itself for respective shooters may also be appended to the table information 261. It is also possible to configure the table information 261 to be output together with image data to an apparatus external to the shooting apparatus 100.

Herein, the fingerprint detector 126 may be configured to detect a fingerprint at the portion where the user of the input unit 131 makes a conscious decision, such as at the release button, for example. In other words, the fingerprint detector 126 may be configured to detect a fingerprint of the finger 12 that depresses the release button. In this case, the processing in steps S121 and S122 may be conducted in parallel.

Additionally, if biometric data acquisition fails at this point, the biometric data acquirer 241 may be configured to prevent execution of processing on the basis of the user instructions received by the instructions receiver 242, and instead prompt the user for biometric data input.

Also, when updating image data, the biometric data of the updater may also be assigned. The process conducted in this case is basically similarly to the image data generation process described earlier.

### [Image Display]

As described above, by associating the biometric data of the user who issued instructions with image data generated or updated on the basis of those instructions, the biometric data can be used for controls conducted when the image data is used. For example, when a user views images expressed by image data stored in the storage unit 124, the controller 111 is able to acquire the user's biometric data, and thereby display the images for the image data associated with the biometric data of that user.

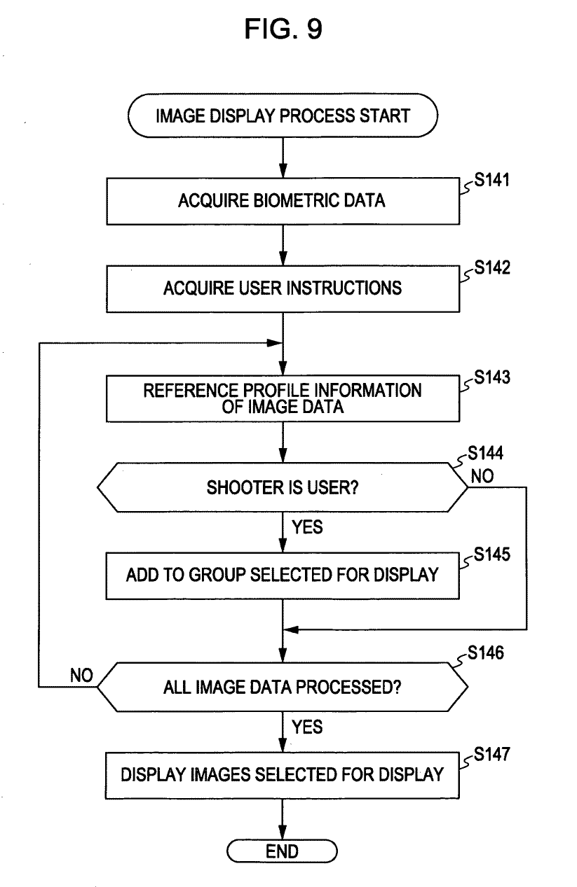

The flow of such an image display process in accordance with an embodiment of the present invention will now be described with reference to the flowchart shown in FIG. 9.

In this example, when the user selects a viewer mode for viewing images as the operational mode of the shooting apparatus 100, the controller 111 transitions to viewer mode, and initiates the image display process.

Once the image display process is initiated, in step S141 the biometric data acquirer 241 controls the fingerprint detector 126 to acquire the biometric data of the user (i.e., the viewer). The user (viewer) causes a fingerprint of his or her finger 12 to be detected by the fingerprint detector 126, and operates the input unit 131 to issue instructions for image viewing.

In step S142, the instructions receiver 242 receives the user instructions input via the input unit 131. Since the user instructions are for image viewing, in step S143 the image data search unit 246 selects a processing target from the image data stored in the storage unit 124, and then references the profile information for the selected image data. In the profile information, the biometric data of the shooter is associated with the image data, as described earlier. Herein, if the biometric data of the shooter is appended to the image data (or its metadata), then the image data search unit 246 may be configured to reference the biometric data appended to the image data (or its metadata).

In step S144, the image data search unit 246 determines whether or not the shooter of the image data currently set as the processing target is also the current user. If the shooter is determined to be the user, then the process proceeds to step S145.

In step S145, the image data search unit 246 adds the current image data (i.e., the image expressed thereby) to a group of images selected for display. Once the processing in step S145 ends, the process proceeds to step S146. Meanwhile, if the shooter is determined in step S144 to not be the user, then the process proceeds to step S146.

In step S146, the image data search unit 246 determines whether or not all image data has been processed. If unprocessed image data is determined to exist, then the process returns to step S143, and the processing in step S143 and thereafter is repeated. Meanwhile, if it is determined in step S146 that all image data has been processed, then the process proceeds to step S147.

In step S147, the search results display unit 247 causes the images expressed by the image data selected for display to be displayed on the display unit 125. Once the processing in step S147 ends, the image display process is terminated.

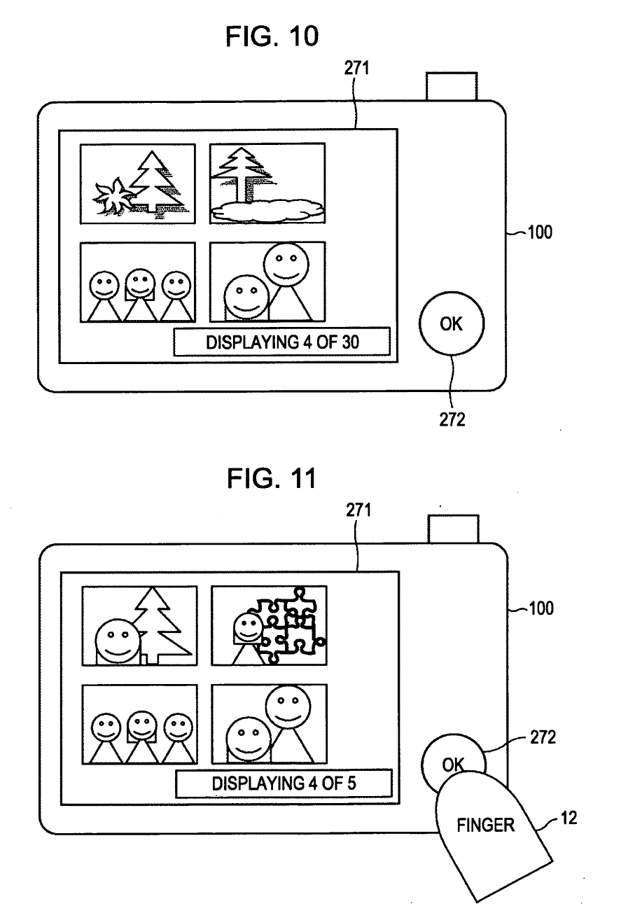

By using a method for restricting image viewers in this way, it is possible to, for example, refine the images to be displayed. FIG. 10 is a schematic diagram for explaining, by way of example, the display of shot images in accordance with an embodiment of the present invention. The state shown in FIG. 10 is a state wherein all images can be viewed. On a display screen 271 displayed on the display (i.e., the display unit 125) provided on the chassis of the shooting apparatus 100, (a portion of) a list of the images expressed by all the image data stored in the storage unit 124 is displayed. When the user selects a single image from this list and operates the OK button 272, the selected image is enlarged on the display screen 271 (or displayed using the entire display screen 271).

At this point, if image data for several hundred or several thousand shot images is being stored in the storage unit 124, then the shooting apparatus 100 will display a list of all of the images on the display screen 271. Thus, the above involves the user searching for the desired image by viewing the list of all images before displaying the desired image.

Consequently, as a result of the controller 111 using the biometric data of the user (i.e., the viewer) to conduct an image display control as described with reference to the flowchart in FIG. 9, the shooting apparatus 100 is able to decrease the number of images displayed on the display screen 271.

FIG. 11 is a schematic diagram for explaining the display of shot images in accordance with an embodiment of the present invention. As shown in FIG. 11, when the user (i.e., viewer) operates the OK button 272 with his or her finger 12 during the state shown in FIG. 10, for example, the shooting apparatus 100 detects a fingerprint of the finger 12, and causes only the images associated with that fingerprint to be displayed. In other words, the images for which the user (i.e., viewer) is the shooter are displayed.

For example, when a Mother viewer operates the OK button 272, only the images shot by Mother are returned by search and displayed. For example, if Mother often shoots Daughter, then by this refinement, many images of Daughter are selected and displayed from among a large number of images. By configuring the shooting apparatus 100 in this way, the Mother viewer interested in the Daughter subject is able to easily search for and view Daughter images from among a large number of images.

Not being limited to the above example, in general a user is often more interested in images he or she shot himself than in images shot by other persons. In other words, most users view images they shot themselves more than others. Consequently, by appending the biometric data of the shooter to image data as described earlier, the controller 111 is able to improve the user-friendliness of image data, and reduce the trouble of the work when viewing and organizing images. As a result, users are able to enjoy viewing and organizing images. In other words, the shooting apparatus 100 is able to improve user satisfaction.

By means of such controls using the biometric data, the controller 111 is herein able to easily realize operation such as not showing files generated or updated by oneself to other persons. For example, the controller 111 may be configured to set a lock flag with respect to a user that specifies “do not show to other persons”. This lock flag may then be forcibly added to the search conditions. In so doing, when this lock flag has been set, then during an image search the controller 111 is able to determine that the images whose shooter is that user are restricted from viewing. Herein, this lock flag may be set with respect to image data, and the controller 111 may also be enabled to control view permissions and restrictions on a per-image basis.

Also, the shooting apparatus 100 may be configured such that instead of just user biometric data, a user is able to add arbitrary conditions, such as shooting times, to the search conditions using arbitrary logic when conducting an image search. In so doing, a user may conduct searches with complex conditions, such as “evening images, or images shot by user A”, or “images shot by me last August”. The user is thus able to search for and view desired images using a wide variety of methods.

Furthermore, the shooting apparatus 100 may also be configured to allow the registration of face images of shooters. As described earlier, the biometric data of shooters is associated with image data. For example, if a user shoots himself or herself, then the user's own biometric data acquired at that time is associated with the image data expressing the user's own face image. Using the above, a shooter's face can be registered in the shooting apparatus 100.

In so doing, a user (i.e., viewer) is able to simply select a registered face image in order to easily search for images shot by the person with that face. In other words, a user (viewer) becomes able to also easily view images shot by other persons. In so doing, the controller 111 is able to improve the user-friendliness of image data.

### 2. Second Embodiment

### [View-Authorized Person Control]

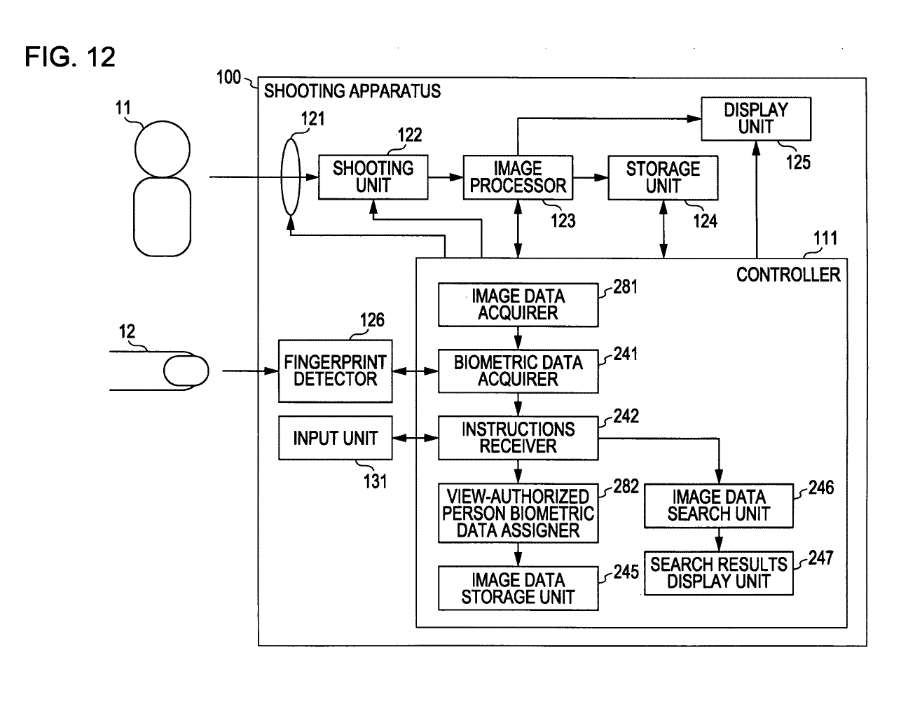

Biometric data may also be associated with image data as usage permission settings for that image data (i.e., content). For example, the biometric data of a user with permission to view an image (i.e., a use-authorized person) may be associated with that image data. FIG. 12 is a block diagram for this case, illustrating the primary configuration of a controller 111 in accordance with another embodiment of the present invention.

As shown in FIG. 12, the controller 111 in this case includes the following function blocks: an image data acquirer 281, a biometric data acquirer 241, an instructions receiver 242, a view-authorized person biometric data assigner 282, an image data storage unit 245, an image data search unit 246, and a search results display unit 247. These function blocks are realized in the controller 111 as a result of a CPU loading and executing programs and data read from ROM into RAM, for example.

The image data acquirer 281 acquires image data stored in the storage unit 124, such as image data that has been selected by the user via the input unit 131, for example. When instructions for executing a process to register the biometric data of a user permitted to view images are received by the instructions receiver 242, the view-authorized person biometric data assigner 282 assigns the user (i.e., viewer) biometric data acquired by the biometric data acquirer 241 to the image data acquired by the image data acquirer 281 as view-authorized person settings (i.e., image data usage permission settings).

The assignment of the biometric data of a view-authorized person is similar to the assignment of the biometric data of a shooter. In other words, profile information may be generated wherein the biometric data or information equivalent to the biometric data is associated with image data.

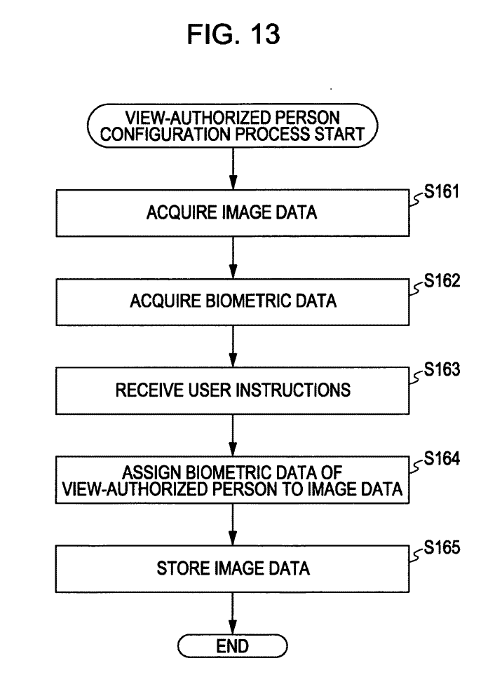

Next, the flow of a view-authorized person configuration process executed by the controller 111 in this case and in accordance with an embodiment of the present invention will be described with reference to the flowchart shown in FIG. 13.

Once the view-authorized person configuration process is initiated, in step S161 the image data acquirer 281 acquires image data from the storage unit 124, such as image data specified by the user via the input unit 131, for example. In step S162, the biometric data acquirer 241 controls the fingerprint detector 126 to detect and acquire the biometric data of the user. In step S163, the instructions receiver 242 receives user instructions input via the input unit 131.

If user instructions for setting a view-authorized person are received in step S163, then in step S164 the view-authorized person biometric data assigner 282 assigns the biometric data acquired in step S162 to the image acquired in step S162 as usage permission settings (i.e., a view-authorized person) for that image data. In step S165, the image data storage unit 245 stores the image data with assigned biometric data.

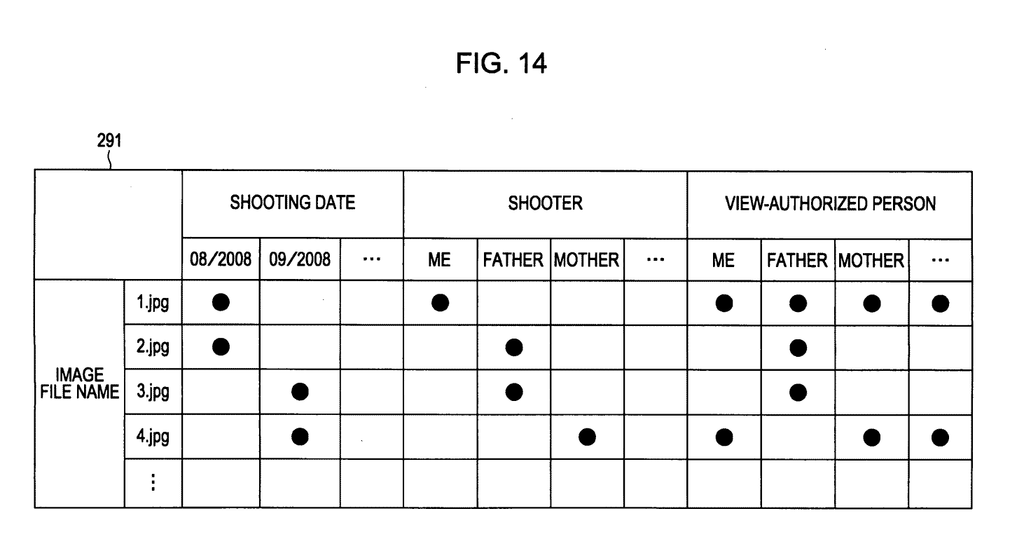

Like the shooter biometric data, the view-authorized person biometric data herein may be associated by means of table information like that shown by way of example in FIG. 14. The table information 291 shown in FIG. 14 is profile information for managing image data. The view-authorized person biometric data assigner 282 associates and manages image data and view-authorized persons in the management information for respective image data as shown in the table information 291.

In other words, in this case, the image data storage unit 245 causes both image data and table information 291 to be stored in the storage unit 124 in step S165.

In addition to the structure of the table information 261 shown in FIG. 8, the table information 291 also includes view-authorized person information. In other words, individual image data is also associated with view-authorized person information. Herein, the biometric data is registered in association with separate user (i.e., shooter) names (IDs). Obviously, the biometric data itself for respective shooters may also be appended to the table information 291. It is also possible to configure the table information 291 to be output together with image data to an apparatus external to the shooting apparatus 100.

Herein, the fingerprint detector 126 may be configured to detect a fingerprint at the portion where the user of the input unit 131 makes a conscious decision, such as at the OK button, for example. In other words, the fingerprint detector 126 may be configured to detect a fingerprint of the finger 12 that depresses the OK button. In this case, the processing in steps S162 and S163 may be conducted in parallel.

In addition, the controller 111 may be configure view-authorized persons without user instructions by following predetermined rules given in advance, such as: images shot by me can be viewed by everyone; images shot by Father can be viewed only by Father; images shot by Mother can be viewed by everyone except Father; and images shot by Mr. XX can be viewed only by persons without registered fingerprints, for example.

Obviously, some cases can involve specifying the users to be subject to such rules. In other words, when it is desirable to explicitly designate a rule with respect to a specific user, then that user's biometric data is first registered. For example, in order to establish rules such as “only Father can view the images” or “everyone except Father can view the images”, the biometric data of this Father user is registered in advance. Meanwhile, in the case of rules such as the above “images shot by me can be viewed by everyone”, such advance biometric data registration can be omitted.

As another example, in the case of rules such as the above “images shot by Mr. XX can be viewed only by persons without registered fingerprints”, biometric data registration may or may not be performed in advance. For example, a shooting apparatus 100 owned by a school may be used to shoot photos depicting stated information such as the school's location, as well as photos depicting the school itself. If the rule “only persons without registered fingerprints can view the images” is imposed, then the above image information can be used as information for when the camera is lost, and be provided to the finder of the camera. Thus, in so doing, information similar to stating the school name and address on the chassis of the shooting apparatus 100 or even more useful information can be provided to the finder. Furthermore, if the shooting apparatus 100 is configured such that users with unregistered biometric data are unable to view other images at this point, the presentation of non-relevant information to the finder can be prevented.

When viewing images, information is added to the search conditions indicating whether or not the biometric data of the user (i.e., the viewer) is registered as a view-authorized person. The image data search unit 246 then conducts a search on the basis of the user's biometric data and the search conditions. The search results display unit 247 causes the images returned by the search conducted in this way to be displayed on the display unit 125. For example, if the biometric data of the user (viewer) is not registered as a view-authorized person, then the display of such images may be prohibited.

In so doing, image view settings can be more flexibly configured. As a result, the user-friendliness of image data is improved, and users are able to more easily use information.

### 3. Third Embodiment

### [Settings Control]

An image expressed by image data with assigned biometric data may be a motion image or a still image. In addition, data other than image data may also be used, such as audio data or text data, for example. Furthermore, such data is not limited to being data for content such as images or audio, and may also be device settings data or similar information, for example.

For example, the shooting apparatus 100 may manage settings data defining its settings by associating such data with biometric data. The shooting apparatus 100 may then be configured such that, on the basis of the biometric data of a user, settings data corresponding to the biometric data is read and applied or updated.

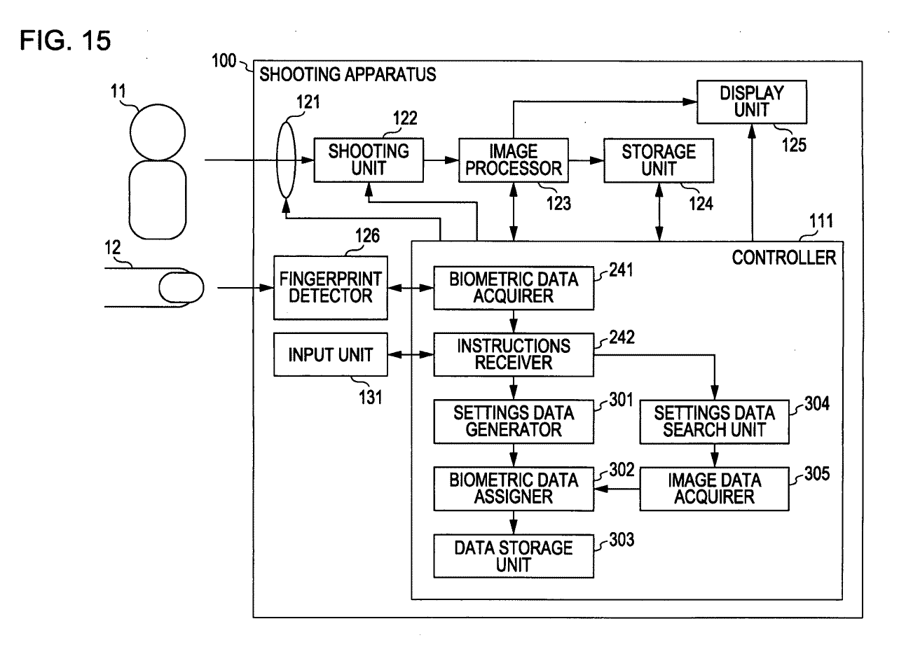

FIG. 15 is a block diagram illustrating the primary configuration of a controller 111 in this case and in accordance with another embodiment of the present invention.

In the shooting apparatus 100 shown in FIG. 15, the controller 111 includes the following function blocks: a biometric data acquirer 241, an instructions receiver 242, a settings data generator 301, a biometric data assigner 302, a data storage unit 303, a settings data search unit 304, and an image data acquirer 305. These function blocks are realized in the controller 111 as a result of a CPU loading and executing programs and data read from ROM into RAM, for example.

The settings data generator 301 generates settings data for the shooting apparatus 100 according to user instructions received by the instructions receiver 242 via the input unit 131. The biometric data assigner 302 assigns biometric data acquired by the biometric data acquirer 241 via the fingerprint detector 126 to settings data generated by the settings data generator 301. The data storage unit 303 causes settings data with biometric data assigned by the biometric data assigner 302 to be stored in the storage unit 124. The settings data search unit 304 reads out, from the storage unit 124, settings data corresponding to biometric data obtained by the biometric data acquirer 241 via the fingerprint detector 126. Following the settings, the image data acquirer 305 controls the components from the optics 121 to the display unit 125, causes a subject to be shot, and acquires image data for the shot image.

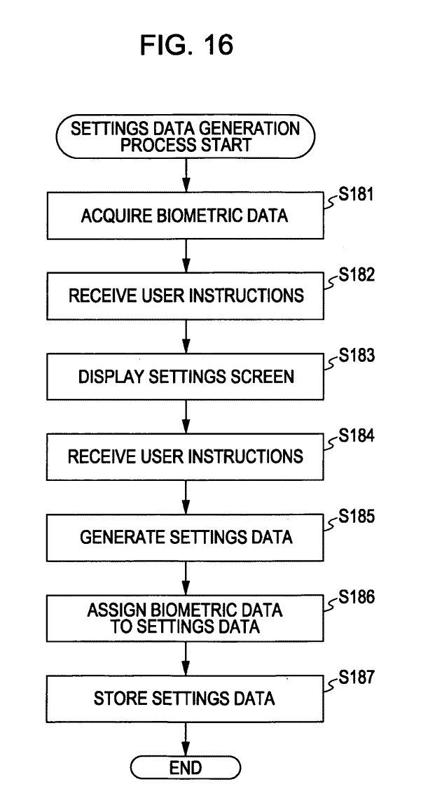

The flow of a settings data generation process executed by such a controller 111 in accordance with an embodiment of the present invention will now be described with reference to the flowchart shown in FIG. 16.

The user applying settings causes the fingerprint detector 126 to detect a fingerprint of his or her finger 12, and inputs settings registration instructions into the input unit 131. In step S181, the biometric data acquirer 241 controls the fingerprint detector 126 to acquire the biometric data of the user applying settings. In step S182, the instructions receiver 242 receives the user instructions input via the input unit 131.

Herein, the fingerprint detector 126 may be configured to detect a fingerprint of the finger 12 as the user inputs settings registration instructions into the input unit 131. In this case, the processing in step S181 may be executed in parallel with the processing in step S182.

Once user instructions specifying the registration of settings data are received, in step S183 the settings data generator 301 causes a settings screen for configuring the settings of the shooting apparatus 100 to be displayed on the display unit 125. By operating the input unit 131 in accordance with this settings screen, the user inputs setting values. In step S184, the instructions receiver 242 receives the user instructions related to the settings of the shooting apparatus 100 that were input into the input unit 131 with respect to the settings screen.

Herein, the fingerprint detector 126 may also be configured to detect a fingerprint of the finger 12 as the user inputs the user instructions related to the settings of the shooting apparatus 100 into the input unit 131. In this case, the processing in step S181 may be executed in parallel with the processing in step S183.

In step S185, the settings data generator 301 applies settings to the shooting apparatus 100 on the basis of the user instructions received by means of the processing in step S184, and thereby generates settings data. In step S186, the biometric data assigner 302 assigns the biometric data acquired in step S181 to the settings data generated in step S185. In step S187, the data storage unit 303 causes the settings data with assigned biometric data to be stored in the storage unit 124.

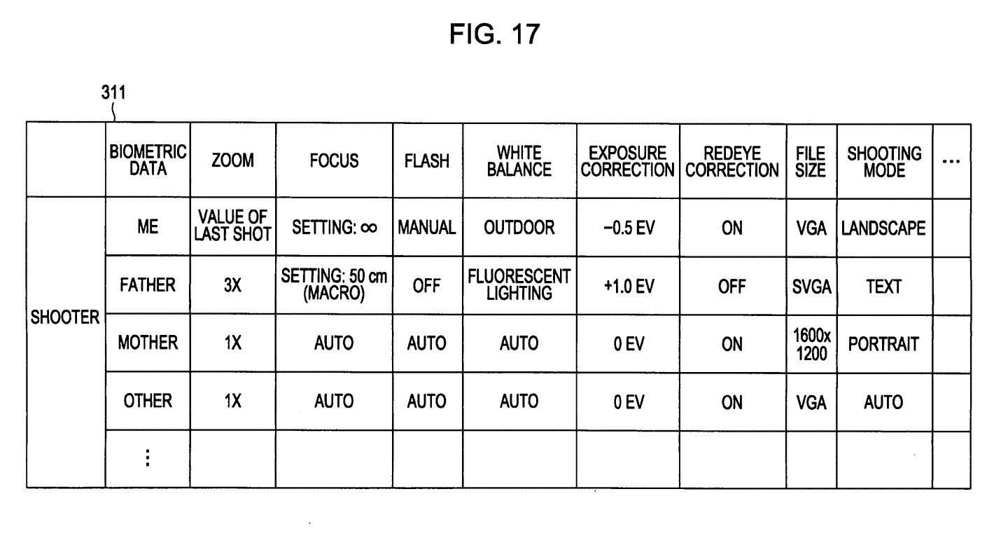

FIG. 17 is a schematic diagram illustrating settings data generated by a process like the above in accordance with an embodiment of the present invention.

As shown in FIG. 17, settings information for the shooting apparatus 100 is registered in the table information 311 for each user (i.e., shooter) already registered in association biometric data. The settings information contains items primarily related to shooting, such as zoom, focus, flash, white balance, exposure correction, redeye correction, file size (i.e., image resolution), and shooting mode settings, for example.

### [Settings Control Usage]

When shooting, for example, the controller 111 causes the user to input biometric data, and on the basis of the user's biometric data thus acquired, the controller 111 is able to identify the shooter as well as read out and define various settings corresponding to that shooter. Consequently, by simply inputting one's own biometric data, a user is able to more easily apply settings to the shooting apparatus 100.

In the present case, it is also possible for a user's biometric data to be assigned to image data obtained by shooting, similarly to that described in the foregoing. At this point, the biometric data is acquired in order to select settings data, and thus the controller 111 is able to assign that biometric data to image data.

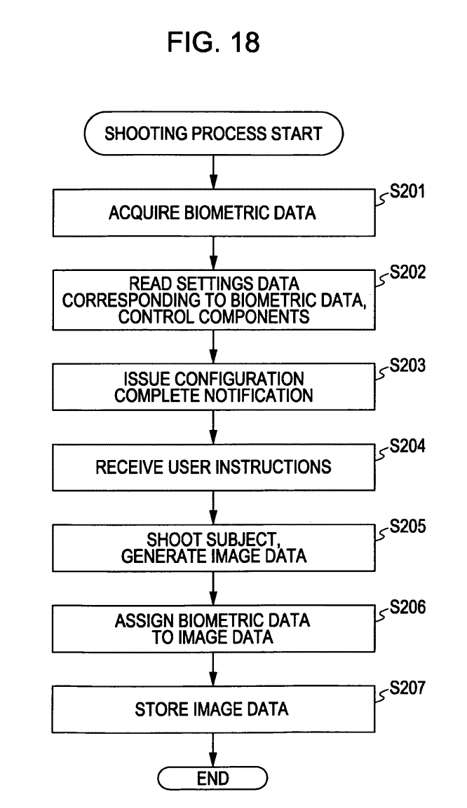

The flow of such a shooting process in accordance with an embodiment of the present invention will now be described with reference to the flowchart shown in FIG. 18.

When shooting a subject 11, the user switches the operational mode of the shooting apparatus 100 to shoot mode, and causes a fingerprint of his or her own finger 12 to be detected by the fingerprint detector 126, which causes shooting-related settings that have been registered in advance to be read out and applied.

The shooting process is initiated upon switching to shoot mode. In step S201, the biometric data acquirer 241 controls the fingerprint detector 126 to acquire the user's biometric data. In step S202, the settings data search unit 304 reads out the settings data corresponding to the biometric data, and controls respective components in accordance with these settings. Once the configuration of settings is complete, in step S203 the settings data search unit 304 issues a configuration complete notification by controlling the display unit 125, for example.

On configuration is complete, the user inputs user instructions for shooting into the input unit 131 by depressing or otherwise operating a release button, for example. In step S204, the instructions receiver 242 receives the user instructions for shooting the subject 11.

Once user instructions for shooting are received in step S203, in step S205 the image data acquirer 305 controls the components from the optics 121 to the display unit 125 to shoot the subject and generate image data.

In step S206, the biometric data assigner 302 assigns the biometric data that was acquired in order to select settings data in step S201 to the image data acquired in step S205. In step S207, the data storage unit 303 causes the image data with assigned biometric data to be stored in the storage unit 124.

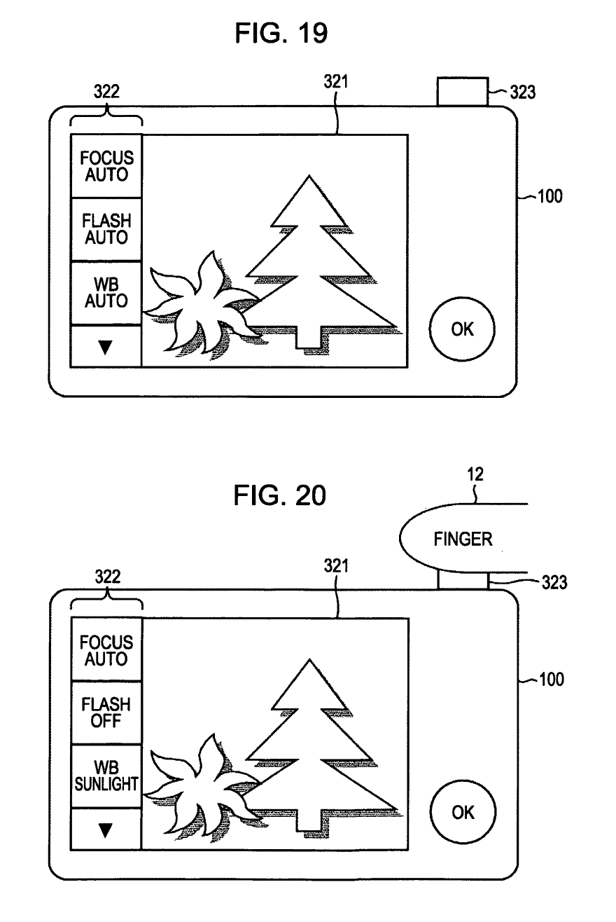

FIG. 19 is a schematic diagram for explaining the display of shooting settings in accordance with an embodiment of the present invention. On the display (i.e., the display unit 125) of the shooting apparatus 100, there are displayed a captured image 321 as well as setting values 322 for various shooting-related settings. For example, before biometric data is acquired (in other words, in the state where a shooter is not specified), the setting values 322 for settings such as focus (FOCUS), flash (FLASH), and white balance (WB) are set to automatic (AUTO), as shown in FIG. 19.

FIG. 20 is a schematic diagram for explaining the display of shooting settings in accordance with another embodiment of the present invention. For example, when the user depresses the release button 323, a fingerprint of the finger 12 that depressed the release button 323 may be detected by the fingerprint detector 126, and the shooter may be specified. Once the shooter is specified, that shooter's settings are read out and applied, and those setting values 322 are displayed. In the case of the example shown in FIG. 20, the flash setting (FLASH) is changed to “OFF”, while the white balance setting (WB) is changed to “SUNLIGHT”.

In so doing, as a result of a user simply depressing a release button in order to shoot a subject, that user's biometric data can be detected, the biometric data can be used to apply the settings assigned to that user, and then shooting can be conducted, without the user performing any operations for applying settings. In other words, the user is able to easily apply settings registered in advance. Also, as shown in FIGS. 19 and 20, as a result of the shooting apparatus 100 displaying the currently-applied setting values, the user is able to easily check the setting values.

It should be appreciated that the particular settings to be associated with biometric data are arbitrary, and that settings other than those given above may be used.

The method for acquiring biometric data is also arbitrary. For example, fingerprint detection may be conducted at a location different from that of the release button 323. For example, if the user operates an OK button before depressing the release button 323, then a fingerprint of the user's finger 12 operating the OK button may be detected. In this case, at the time the release button 323 is depressed, settings are applied that correspond to the fingerprint of the finger 12 that last operated the OK button, for example. As another example, iris authentication of eyes looking at the finder may be continuously conducted, with the settings of the user specified by the most recent iris authentication being continually applied in response to any changes.

Additionally, settings may also be registered for each of the user's fingers. For example, different settings may be assigned to the thumb, index finger, middle finger, and ring finger, respectively. In so doing, by simply changing the finger used to input a fingerprint, a user is able to easily change the settings to be applied.

Furthermore, the shooting apparatus 100 may also be configured to enable the assignment of settings to combinations of multiple fingers. In so doing, a user is able to register an even greater number of settings patterns. A plurality of settings patterns may also be registered with respect to a single set of biometric data. In this case, one pattern among the multiple settings patterns based on the biometric data may be selected, read out, and applied, for example. Alternatively, multiple settings patterns based on the biometric data may be read out, and the user may then select a single pattern from among those patterns.

As another example, if predetermined biometric data is input, or if biometric data is input using a predetermined method, then settings other than those assigned to one's own biometric data may be read out. For example, if a fingerprint of the little finger is input, then the settings of another user may be randomly read out and applied. Alternatively, settings determined to be appropriate by the shooting apparatus 100 may be applied.

### 4. Fourth Embodiment

### [User Data Management]

The biometric data of a user may also be assigned to that user's user data. Herein, user data is data expressing registration information regarding users registered in the shooting apparatus 100. In so doing, user data can be used in conjunction with that user's biometric data.

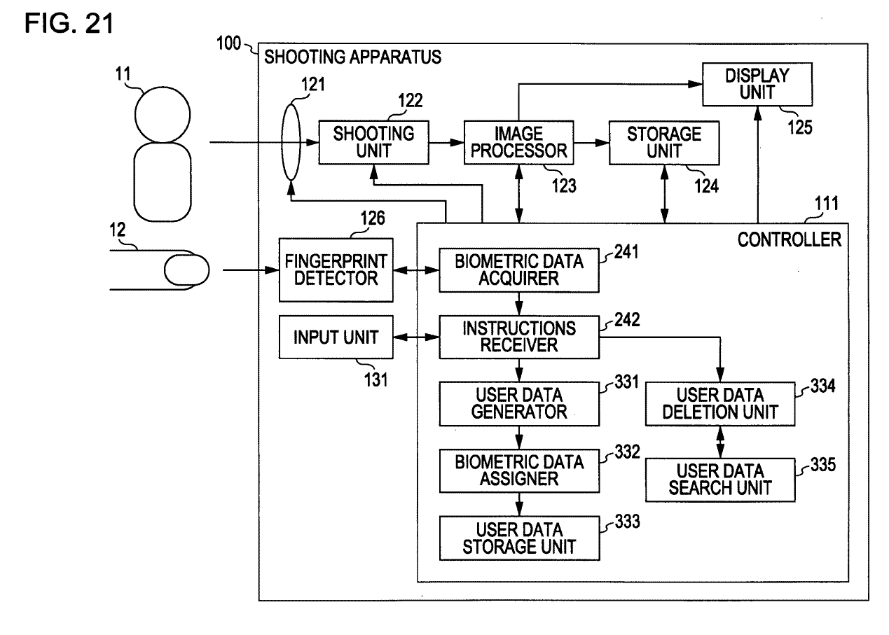

FIG. 21 is a block diagram illustrating the primary configuration of a controller 111 in this case and in accordance with another embodiment of the present invention.

In the shooting apparatus 100 shown in FIG. 21, the controller 111 includes the following function blocks: a biometric data acquirer 241, an instructions receiver 242, a user data generator 331, a biometric data assigner 332, a user data storage unit 333, a user data deletion unit 334, and a user data search unit 335. These function blocks are realized in the controller 111 as a result of a CPU loading and executing programs and data read from ROM into RAM, for example.

The user data generator 331 generates user data in accordance with user instructions received by the instructions receiver 242. The user data is user registration information, and may include information such as a user ID identifying the user, and a group ID identifying a group to which the user belongs. The biometric data assigner 332 assigns biometric data acquired by the biometric data acquirer 241 to user data generated by the user data generator 331. The user data storage unit 333 causes user data with biometric data assigned by the biometric data assigner 302 to be stored in the storage unit 124.

The user data deletion unit 334 deletes user data stored in the storage unit 124 in accordance with user instructions received by the instructions receiver 242. The user data search unit 335 searches for particular user data among the user data stored in the storage unit 124, such as user data desired by the user data deletion unit 334, for example.

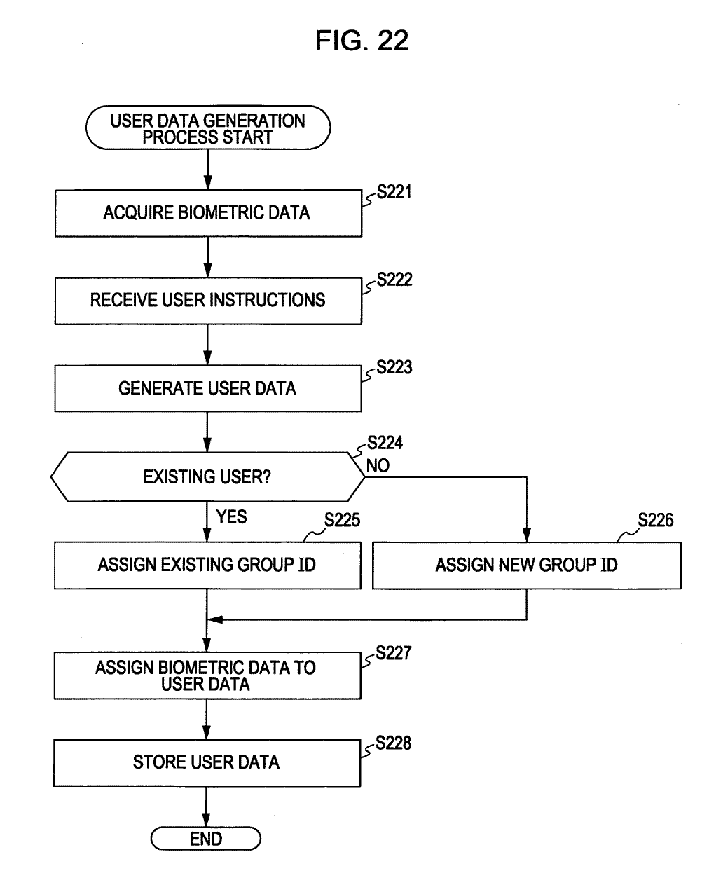

The flow of a user data generation process executed by such a controller 111 in accordance with an embodiment of the present invention will now be described with reference to the flowchart shown in FIG. 22.

A user performing user registration causes a fingerprint of his or her finger 12 to be detected by the fingerprint detector 126, and inputs user instructions in the form of user-related information into the input unit 131. In step S221, the biometric data acquirer 241 controls the fingerprint detector 126 to acquire the biometric data of the user performing user registration. In step S222, the instructions receiver 242 receives the user-related information or similar user instructions input via the input unit 131.

Herein, the fingerprint detector 126 may also be configured to detect a fingerprint of the finger 12 as the user inputs user instructions into the input unit 131. In this case, the processing in step S221 may be executed in parallel with the processing in step S222.

In step S223, the user data generator 331 generates user data on the basis of the user instructions received in step S222. In step S224, the user data generator 331 determines whether or not the user requested to be registered by the user instructions received in step S222 is an existing user. It is possible to register biometric data for each finger, for example, and user data may be plurally generated for a single user.

If it is determined that the user is already registered, then the process proceeds to step S225. In step S225, the user data generator 331 assigns an existing group ID to which that user belongs. Once the processing in step S225 ends, the process proceeds to step S227.

On the other hand, if it is determined step S224 that the user requested to be registered by the user instructions received in step S222 is a new user, then the process proceeds to step S226. In step S226, the user data generator 331 assigns a new group ID. Once the processing in step S226 ends, the process proceeds to step S227.

In step S227, the biometric data assigner 332 assigns biometric data to the user data. In step S228, the user data storage unit 333 stores the user data that was assigned biometric data in step S227. Once the processing in step S228 ends, the user data generation process is terminated.

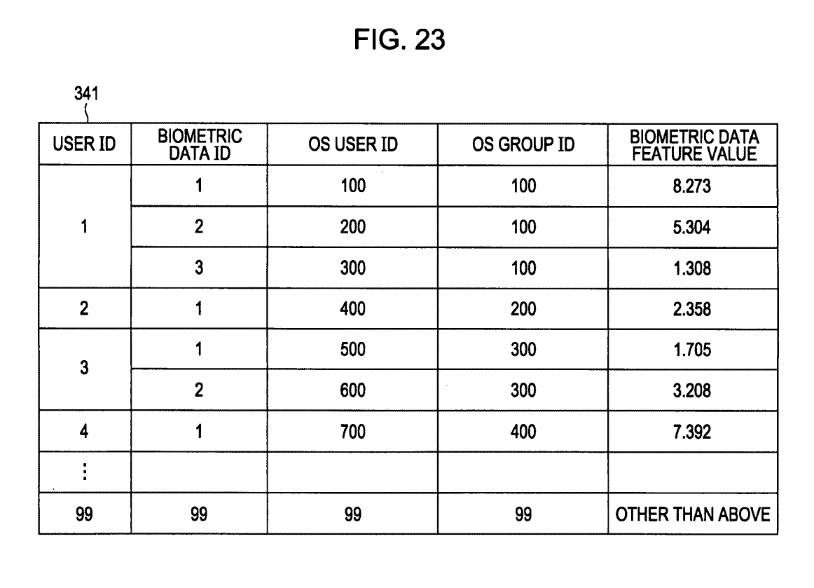

FIG. 23 is a schematic diagram for explaining table information indicating relationships between user identification information and biometric data. The table information 341 shown in FIG. 23 is a collection of user data with assigned biometric data, wherein the biometric data is respectively assigned to identification information for each user.

For example, the user with the user ID 1 is associated with three sets of biometric data with biometric data IDs 1 to 3. Each set of biometric data is assigned an OS (Operating System) user ID and group ID, for example. In the case of the embodiment shown in FIG. 23, each set of biometric data is identified by the OS user ID, while each user is identified by the OS group ID.

In the case of the embodiment shown in FIG. 23, a feature value for each set of biometric data is registered in the table information 341. This feature value may be any quantity. For example, the feature value may be fingerprint image data, or alternatively, information equivalent to the biometric data, such as link information indicating where the biometric data is saved.

As shown by the respective biometric data feature value herein, the biometric data ID is information identifying the biometric data assigned to each user. For example, the biometric data ID 1 associated with the user ID 1 is identification information indicating a single set of biometric data for the user with the user ID 1, with that biometric data feature value being 8.273. As another example, the biometric data ID 2 associated with the user ID 2 is identification information indicating a single set of biometric data for the user with the user ID 2, with that biometric data feature value being 2.358. In other words, while the above biometric data IDs are both 1, they refer to respectively different biometric data.

Herein, a user ID may also be provided for all users other than the registered users, like the user ID 99 shown in FIG. 23.

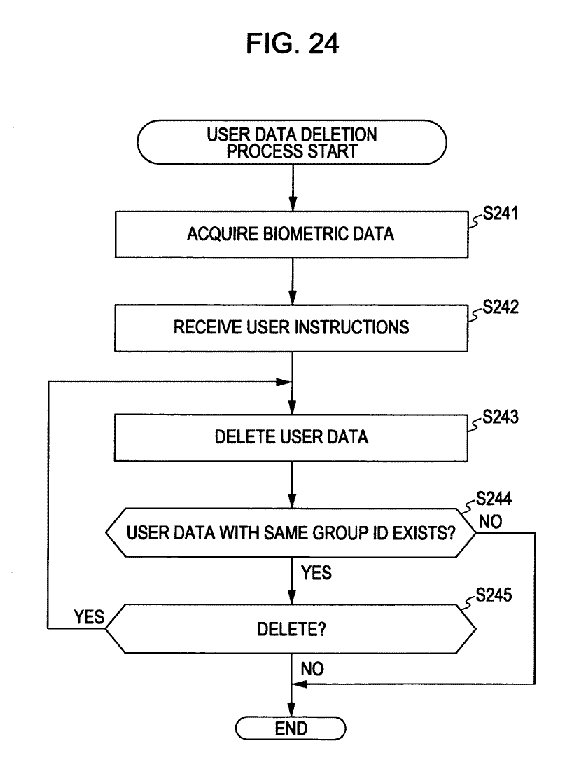

The flow of a user data deletion process for deleting such user data in accordance with an embodiment of the present invention will now be described with reference to the flowchart shown in FIG. 24.

A user performing user data deletion causes a fingerprint of his or her finger 12 to be detected by the fingerprint detector 126, and inputs instructions for deleting user data into the input unit 131. In step S241, the biometric data acquirer 241 controls the fingerprint detector 126 to acquire the biometric data of the user performing user data deletion. In step S242, the instructions receiver 242 receives the user instructions input into the input unit 131.

Herein, the fingerprint detector 126 may also be configured to detect a fingerprint of the finger 12 as the user inputs instructions for deleting user data into the input unit 131. In this case, the process in step S241 may be executed in parallel with the processing in step S242.

Once the user instructions for deleting user data are received, in step S243 the user data deletion unit 334 deletes the user data specified by the user instructions. In step S244, the user data search unit 335 determines whether or not there exists other user data having the same group ID as that of the user data that was deleted in step S243. If it is determined that user data with the same group ID exists, then the process proceeds to step S245.

In step S245, the user data deletion unit 334 determines whether or not to delete the user data. If it is determined that the user data is to be deleted (on the basis of user instructions, for example), then the process returns to step S243, and the processing in step S243 and thereafter is repeated. If it is determined in step S245 that the user data is not to be deleted, or alternatively, if it is determined in step S244 that user data with the same group ID does not exist, then the user data deletion process is terminated.

In this way, the user is able to use biometric data to easily register and delete user data.

### 5. Fifth Embodiment

### [Associating User Data and Settings]

User data like the above may also be associated with other information. For example, settings data for the shooting apparatus 100 as described earlier may also be associated with user data.

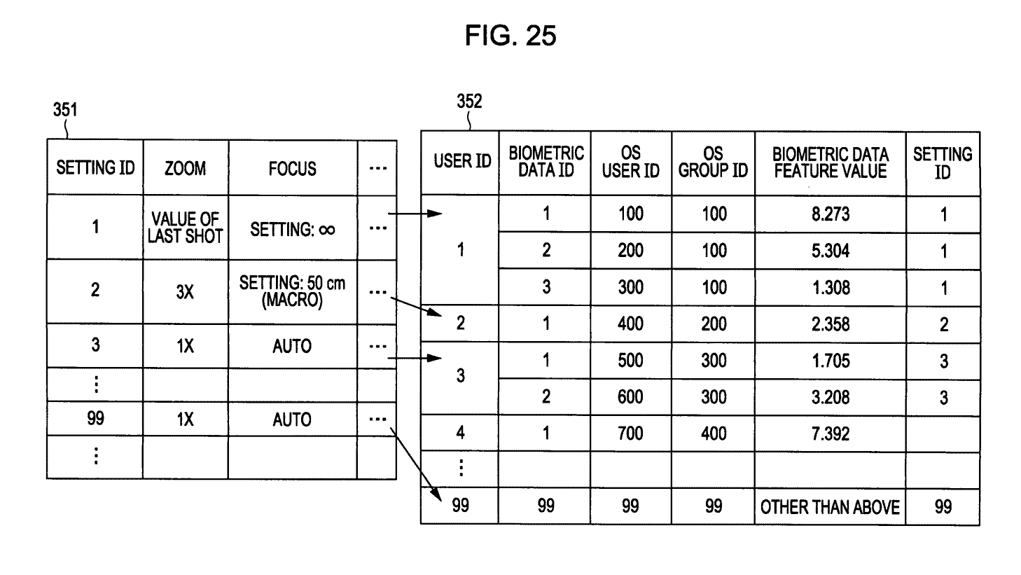

FIG. 25 is a schematic diagram for explaining how shooting settings table information and user data table information are associated in accordance with an embodiment of the present invention.

The settings data 351 shown in FIG. 25 is table information indicating settings for the shooting apparatus 100 that are related to shooting, for example. This settings data 351 is basically similar to the table information 311 described with reference to FIG. 17. In other words, the settings data 351 stores the respective values of various settings as table data, and contains items primarily related to shooting, such as zoom, focus, flash, white balance, exposure correction, redeye correction, file size (i.e., image resolution), and shooting mode settings, for example. However, while the values for each setting are collected for each set of biometric data in the case of the table information 311, values for each setting are collected for each setting ID in the settings data 351. In other words, each setting ID is information indentifying a specific combination of values for various settings. The biometric data itself is not directly associated with individual setting IDs (i.e., combinations of setting values) in the settings data 351.

The biometric data is managed in user data 352. The user data 352 is information similar to the table information 341 described with reference to FIG. 23. In other words, the user data 352 is information used to manage per-user biometric data. The user ID is information identifying a user, while the biometric data ID is information identifying the biometric data for a particular user. The OS user ID and the OS group ID are a user ID and a group ID assigned to each set of biometric data by the OS. The biometric data feature value expresses a feature value for a particular set of biometric data.

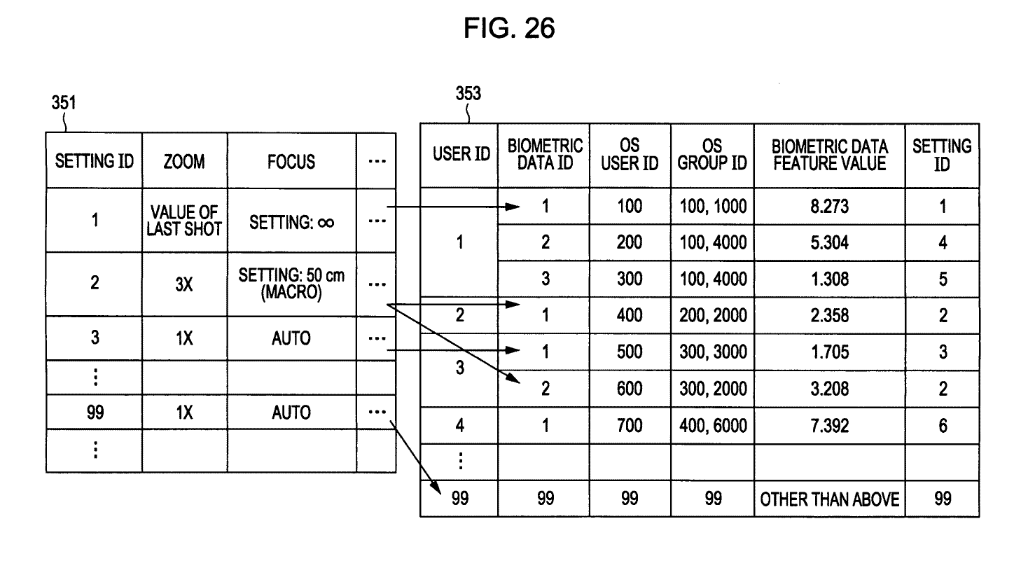

Similarly to that shown in FIG. 23, the biometric data ID in the user data 352 is information identifying biometric data for a single user. Consequently, the biometric data with the biometric data ID 1 for the user ID 1 (having a biometric data feature value of 8.273) differs from the biometric data with the biometric data ID 1 for the user ID 2 (having a biometric data feature value of 2.358). The above is also similar for FIG. 26 and thereafter.

In the example shown in FIG. 25, the setting IDs in the settings data 351 are registered in the user data 352. In so doing, a combination of setting values registered in the settings data 351 is associated with each user registered in the user data.

For example, in the user data 352, the setting ID 1 is registered with respect to each set of biometric data for the user ID 1. In other words, the combination of setting values with the setting ID 1 are assigned to the user with the user ID 1. Consequently, if the user with the user ID 1 causes biometric data (i.e., a fingerprint) with the biometric data IDs 1 to 3 to be detected by the fingerprint detector 126, then the various setting values associated with the setting ID 1 are read out and applied as the settings of the shooting apparatus 100, for example.

As another example, the setting ID 2 is registered with respect to the biometric data for the user ID 2 in the user data 352. In other words, the combination of setting values with the setting ID 2 is assigned to the user with the user ID 2. Consequently, if the user with the user ID 2 causes biometric data (i.e., a fingerprint) with the biometric data ID 1 to be detected by the fingerprint detector 126, then the various setting values associated with the setting ID 2 are read out and applied as the settings of the shooting apparatus 100.

As a further example, the setting ID 3 is registered with respect to the biometric data for the user ID 3 in the user data 352. In other words, the combination of setting values with the setting ID 3 is assigned to the user with the user ID 3. Consequently, if the user with the user ID 3 causes biometric data (i.e., a fingerprint) with the biometric data ID 1 or 2 to be detected by the fingerprint detector 126, then the various setting values associated with the setting ID are read out and applied as the settings of the shooting apparatus 100.

In this way, by using the user data 352, the association of respective setting IDs (i.e., combinations of setting values) in the settings data 351 with particular users (i.e., association on a per-user basis) is easily realized.

Obviously, the assignment of setting IDs (i.e., combinations of setting values) herein may also be made with respect to individual sets of biometric data. Also, a single setting ID (i.e., combination of setting values) may obviously be assigned to multiple users' biometric data.

FIG. 26 is a schematic diagram for explaining how shooting settings table information and user data table information are associated in accordance with another embodiment of the present invention.

In the case of the user data 353 shown in FIG. 26, setting IDs (i.e., combinations of setting values) are assigned to individual sets of biometric data. In other words, different setting IDs (i.e., combinations of setting values) can be assigned to respective sets of biometric data for a single user. For example, in the user ID 1 in the user data 353, the setting ID 1 is registered with respect to the biometric data with the biometric data ID 1, while the setting ID 4 is registered with respect to the biometric data with the biometric data ID 2, and the setting ID 5 is registered with respect to the biometric data with the biometric data ID 3.

As another example, in the user ID 3 in the user data 353, the setting ID 3 is registered with respect to the biometric data with the biometric data ID 1, while the setting ID 2 is registered with respect to the biometric data with the biometric data ID 2.

Furthermore, a single setting ID (i.e., combination of setting values) can also be assigned to multiple sets of biometric data or multiple users. For example, in the user data 353, the setting ID 2 is registered with respect to both the biometric data with the biometric data ID 1 for the user ID 2, as well as the biometric data with the biometric data ID for the user ID 3. In other words, the same setting ID (i.e., combination of setting values) is associated with a plurality of differing biometric data.

In this way, by managing biometric data in user data separate from the settings data, the biometric data associated with the settings data can be easily changed by simply changing the setting ID registered in the user data. In other words, the shooting apparatus 100 is able to easily associate settings and biometric data using a wider variety of methods.

Obviously, arbitrary data other than settings data can be associated with the user data.

Also, by centrally managing the user data (i.e., biometric data) as described above, the controller 111 is able to easily perform processes such as the creation, updating, and deletion of various types of data. Moreover, since user data is managed separately from other data, the controller 111 is able to update just the user data without updating other data associated with the user data.

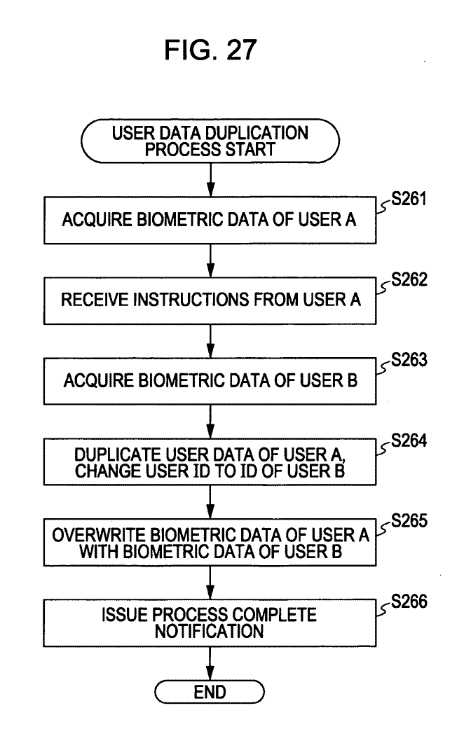

Furthermore, by simply duplicating user data, for example, settings data or similar data associated with user data can be easily inherited by other biometric data. For example, by duplicating the user data of a user A and taking the duplicate to be the user data of a user B, the settings associated with the user A's user data can also be associated with user B's user data. The flow of such a user data duplication process in accordance with an embodiment of the present invention will now be described with reference to the flowchart shown in FIG. 27.

When duplicating user data, first the duplicate provider (i.e., user A) causes a fingerprint of his or her finger 12 to be detected by the fingerprint detector 126. Next, user A or user B operates the input unit 131 to issue instructions for duplicating user data. The duplicate recipient (i.e., user B) then causes a fingerprint of his or her finger 12 to be detected by the fingerprint detector 126.

With respect to the above actions, in step S261 the biometric data acquirer 241 controls the fingerprint detector 126 to acquire the biometric data of the duplicate provider (user A). In step S262, the instructions receiver 242 receives the instructions for duplicating user data input via the input unit 131. In step S263, the biometric data acquirer 241 controls the fingerprint detector 126 to acquire the biometric data of the duplicate recipient (user B).

In step S264, the user data generator 331 duplicates user A's user data, and changes the user ID in the duplicated user data to user B's user ID. In step S265, the biometric data assigner 332 replaces user A's biometric data in the duplicated user data with user B's biometric data. In step S266, the user data storage unit 333 causes the updated user data to be stored in the storage unit 124, and controls the display unit 125 to notify the users that the process is complete. When the processing in step S266 ends, the user data duplication process is terminated.

In so doing, the controller 111 is able to easily generate user data (i.e., biometric data) for user B that is associated with the same settings as those of user A, for example.

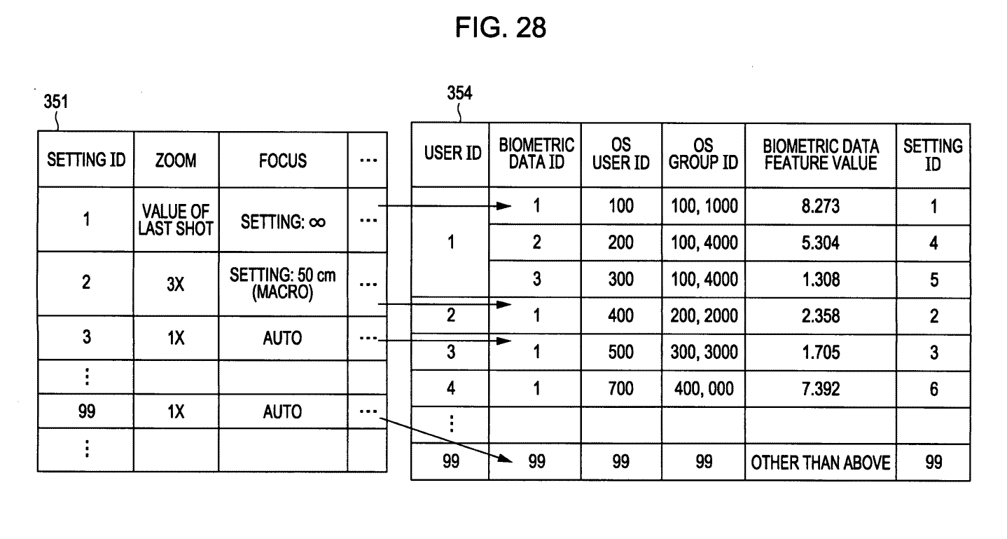

FIG. 28 is a schematic diagram for explaining how shooting settings table information and user data table information are associated in accordance with another embodiment of the present invention.

By way of example, assume that the settings data 351 and the user data 354 are associated with each other as shown in FIG. 28. From this state, when the controller 111 is to generate new biometric data with the biometric data ID 2 for the user ID 3 as shown by way of example in FIG. 26, then the controller 111 duplicates the data with the biometric data ID 1 for the existing user ID 2, as described above. An example of the settings data upon finishing the update at this point is illustrated by the user data 353 in FIG. 26. In so doing, the controller 111 is able to generate new biometric data (i.e., biometric data with the biometric data ID 2 for the user ID 3) that inherits the associations of existing biometric data (i.e., the biometric data with the biometric data ID 1 for the user ID 2).

Obviously, the biometric data is replaced as described above (more specifically, the biometric data feature value or similar information is replaced). In other words, the controller 111 changes information such as the OS user ID, the OS group ID, and the biometric data feature value. Consequently, the newly-generated biometric data ID 2 for the user ID 3 expresses biometric data that differs from that expressed by the biometric data ID of the duplicate provider (i.e., the biometric data ID 1 for the user ID 2).

As a result of the controller 111 simply updating the user data in this way, a user is able to use another user's settings. Consequently, a user is able to mimic another user's settings by performing an easy configuration operation, and without inputting the setting values one-by-one. Thus, it is easy to realize operations such as taking the shooting settings usable with Father's thumbprint that were set in the digital still camera by Father, and making those shooting settings usable by Mother's thumbprint, for example.

### [Transferring User Data To or From Another Apparatus]

Herein, such user data duplication can also be performed among a plurality of apparatus. For example, it is possible to perform operations such as taking the settings associated with one's own biometric data in a shooting apparatus 100A, and making those settings usable with a friend's biometric data in another shooting apparatus 100B.

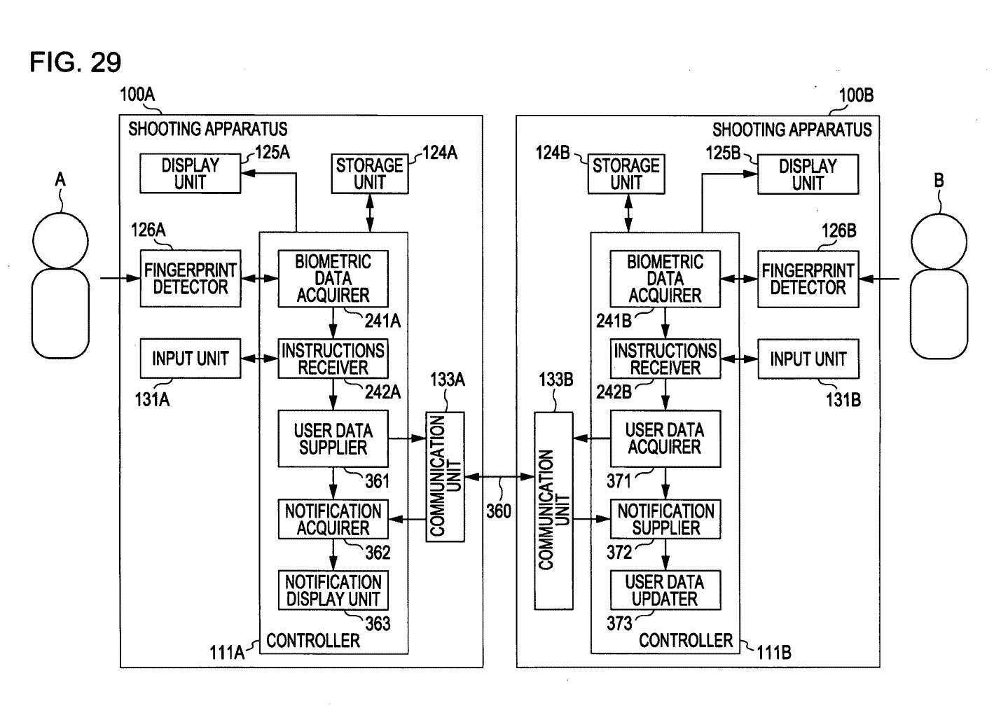

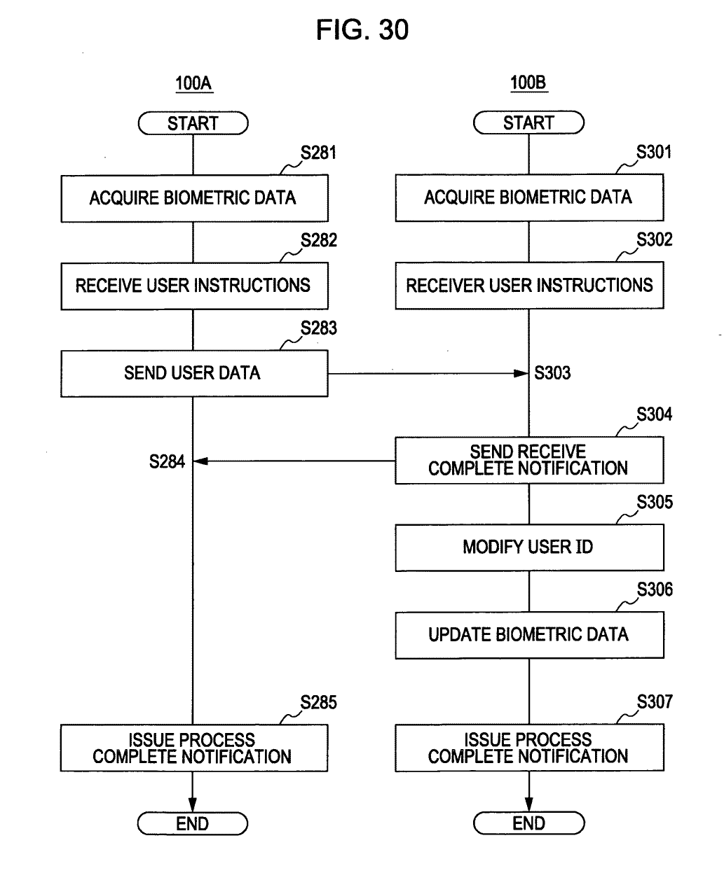

FIG. 29 is a block diagram for this case, illustrating the primary configuration of a shooting apparatus 100A and a shooting apparatus 100B in accordance with another embodiment of the present invention.

As shown in FIG. 29, the controller 111A of the shooting apparatus 100A includes the following function blocks: a biometric data acquirer 241A, an instructions receiver 242A, a user data supplier 361, a notification acquirer 362, and a notification display unit 363.

These function blocks are realized in the controller 111A as a result of a CPU loading and executing programs and data read from ROM into RAM, for example.

On the basis of user instructions received by the instructions receiver 242A, the user data supplier 361 supplies user data for biometric data acquired by the biometric data acquirer 241A to the shooting apparatus 100B via a communication unit 133A. The communication unit 133A communicates with a communication unit 133B in the shooting apparatus 100B via a communication medium 360. The communication medium 360 may be a wired communication medium such as a transmission cable or network, or a wireless communication medium such as an over-the-air medium.

The notification acquirer 362 acquires a notification supplied by the shooting apparatus 100B via the communication unit 133A. The notification display unit 363 causes the notification acquired by the notification acquirer 362 to be displayed on the display unit 125.

Meanwhile, the controller 111B of the shooting apparatus 100B includes a biometric data acquirer 241B, an instructions receiver 242B, a user data acquirer 371, a notification supplier 372, and a user data updater 373.

The user data acquirer 371 acquires user data supplied by the shooting apparatus 100A via the communication unit 133B. The notification supplier 372 issues a notification to the shooting apparatus 100A via the communication unit 133B, the notification indicating that user data was acquired by the user data acquirer 371. The user data updater 373 updates user data in the shooting apparatus 100B.

The flow of a user data duplication process among a plurality of such apparatus in accordance with an embodiment of the present invention will now be described with reference to the flowchart shown in FIG. 30.

When duplicating user data, the user A of the shooting apparatus 100A causes his or her biometric data (i.e., a fingerprint) to be detected by a fingerprint detector 126A, and also operates an input unit 131A to issue instructions for duplicating user data.

Operating in response to such user operations, in step S281 the biometric data acquirer 241A controls the fingerprint detector 126A to acquire user A's biometric data. In step S282, the instructions receiver 242A receives user A's user instructions input via the input unit 131A. Once user data duplication is specified by such user instructions, in step S283 the user data supplier 361 supplies user data to the shooting apparatus 100B via the communication unit 133A.

Meanwhile, the user B of the shooting apparatus 100B causes his or her biometric data (i.e., a fingerprint) to be detected by a fingerprint detector 126B, and also operates an input unit 131B to issue instructions for receiving user data.

Operating in response to such user operations, in step S301 the biometric data acquirer 241B controls the fingerprint detector 126B to acquire user B's biometric data. In step S302, the instructions receiver 242B receives user B's user instructions input via the input unit 131B. Once user data reception is specified by such user instructions, in step S303 the user data acquirer 371 acquires the user data supplied by the shooting apparatus 100A.

Once the user data is acquired, in step S304 the notification supplier 372 controls the communication unit 133B to supply a receive complete notification to the shooting apparatus 100A. In step S284, the notification acquirer 362 acquires, via the communication unit 133A, the receive complete notification supplied by the shooting apparatus 100B. In step S285, the notification display unit 363 controls the display unit 125A to notify user A that the process is complete.

Meanwhile, in step S305, the user data updater 373 of the shooting apparatus 100B changes the user ID in the user data acquired in step S303 to user B's user ID. In step S306, the user data updater 373 replaces (i.e., updates) the biometric data in the user data acquired in step S303 with user B's biometric data. In step S307, the user data updater 373 controls the display unit 125B to notify user B that the process is complete.

In so doing, the controller 111 is able to easily supply user data to another apparatus, as well as acquire user data from another apparatus.

Herein, the controller 111 may also be configured to supply another apparatus with all user data, for example.

Additionally, the duplication of user data as described above may also be configured to occur between different sets of biometric data for the same user. For example, the controller 111 may be configured to duplicate the user data assigned to a particular user's thumb, and generate user data for that user's index finger.

### [Association of User Data, User Operations, and Settings]

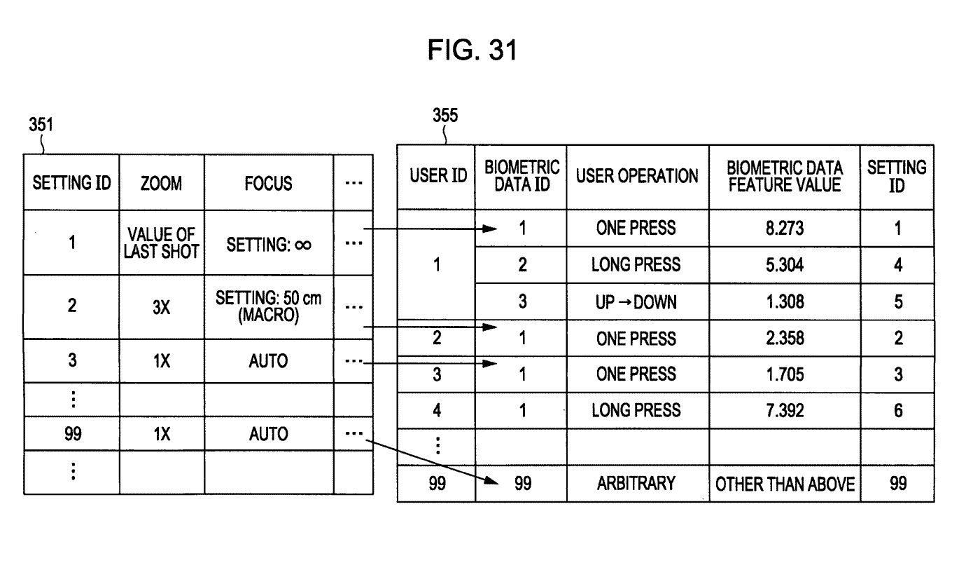

The user operations performed when reading out settings associated with user data may also be defined in the user data. FIG. 31 is a schematic diagram for explaining how shooting settings table information and user data table information are associated in accordance with another embodiment of the present invention. As shown in FIG. 31, in the user data 355, not only is a setting ID associated with each set of user data (i.e., biometric data), but in addition, a user operation for reading the settings is also defined.

For example, the user with the user ID 1 may cause the biometric data with the biometric data ID 1 to be detected by the fingerprint detector 126, while also pressing an OK button once. The user data 355 shows that in so doing, the settings associated with the setting ID 1 will be read out and applied.

By thus associating both the input of biometric data as well as a predetermined user operation with the reading out of settings, the reading out of settings due to an accidental operation can be suppressed.

The foregoing describes the ID of other data being associated with user data. However, other data and user data may be associated with each other by conducting the opposite, wherein a user ID is associated with other data, such as settings data.

The foregoing also describes the biometric data ID as being identification information independently set on a per-user basis, wherein identical biometric data IDs belonging to different users represent different sets of biometric data. However, an embodiment of the present invention is not limited thereto, and the biometric data ID may also be configured to be information identifying biometric data for all users. For example, when the biometric data is taken to be a fingerprint, an embodiment of the present invention may be configured to identify the particular finger of a particular user according to the biometric data ID.

### 6. Sixth Embodiment

### [Command Execution Control]

Biometric data may also be associated with execution availability settings for commands executed in the controller 111. In other words, settings determining whether or not various commands are available for execution may be set for each user in advance, and biometric data for each user may then be associated with those settings. In so doing, when executing a command, the controller 111 is able to use a user's biometric data to easily determine whether or not the execution of that command is available for that user. Herein, the method for assigning biometric data to command execution availability settings is similar to the method of assigning biometric data to settings data as described earlier, and for this reason, further description thereof is omitted.

Hereinafter, the determination of command execution availability when executing a command will be described.

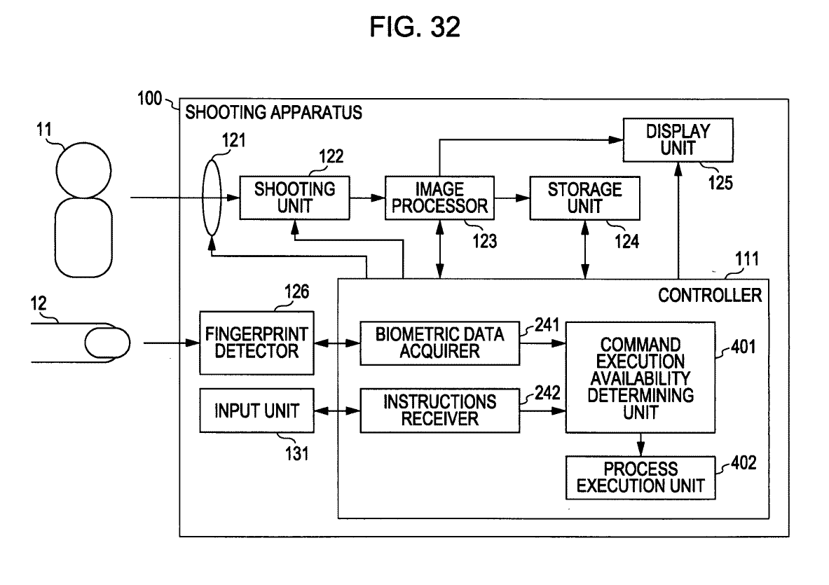

FIG. 32 is a block diagram illustrating the primary configuration of a controller in accordance with another embodiment of the present invention. In FIG. 32, the controller 111 includes the following function blocks: a biometric data acquirer 241, an instructions receiver 242, a command execution availability determining unit 401, and a process execution unit 402. These function blocks are realized in the controller 111 as a result of a CPU loading and executing programs and data read from ROM into RAM, for example.

Using user biometric data acquired by the biometric data acquirer 241, the command execution availability determining unit 401 determines whether or not a user is permitted to execute a command specified by user instructions received by the instructions receiver 242.

If it is determined by the command execution availability determining unit 401 that execution of a command is possible, then the process execution unit 402 executes that command.

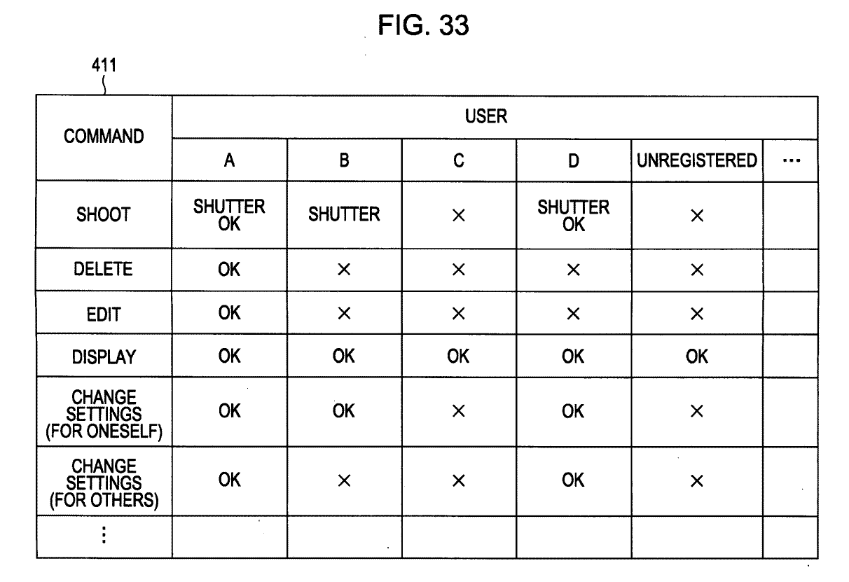

The settings determining the execution availability of various commands is collected in table information 411 shown by way of example in FIG. 33, being managed and stored in the storage unit 124 or similar component. In the table information 411 shown in FIG. 33, the execution availability of each command is set on a per-user basis. Additionally, the user operations that issue instructions for executing each command are also set on a per-user basis. For example, “SHUTTER” in FIG. 33 indicates operating a release button, while “OK” indicates operating an OK button. Herein, “X” indicates that execution is prohibited.

For example, user A is able to issue instructions for executing the “SHOOT” command by operating the release button or operating the OK button. In contrast, user B is able to issue instructions for executing the “SHOOT” command only by operating the release button. As another example, user B is prohibited from changing other users' settings.

The table information 411 thus indicates execution availability settings with respect to each command for each user. Such table information 411 may, for example, be associated with the user data described earlier. Alternatively, biometric data for each user, or data equivalent to the biometric data, may be appended to the table information 411. Consequently, the command execution availability determining unit 401 is able to easily determine the execution availability of a desired command, on the basis of input biometric data and user instructions.

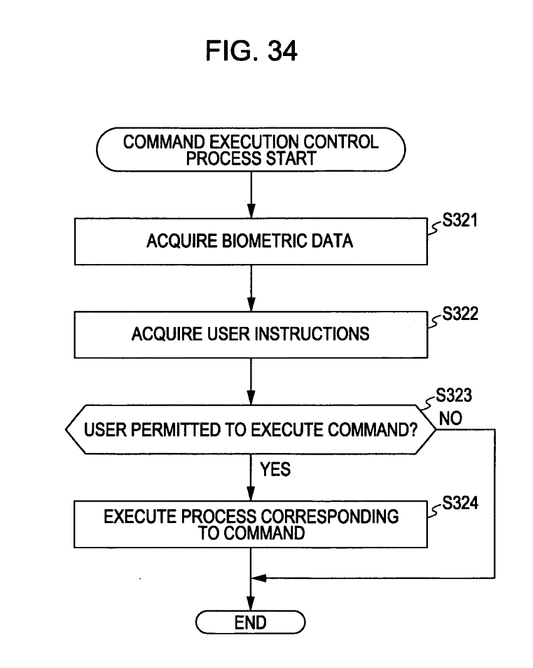

The flow of such a command execution control process for determining command execution availability in accordance with an embodiment of the present invention will now be described with reference to the flowchart shown in FIG. 34.

A user issuing instructions for executing a command causes a fingerprint of his or her finger 12 to be detected by the fingerprint detector 126, and inputs instructions specifying the command to be executed into the input unit 131. In step S321, the biometric data acquirer 241 controls the fingerprint detector 126 to acquire the user's biometric data. In step S322, the instructions receiver 242 receives the user instructions input via the input unit 131.

Herein, the fingerprint detector 126 may also be configured to detect a fingerprint of the finger 12 as the user inputs user instructions into the input unit 131. In this case, the processing in step S321 may be executed in parallel with the processing in step S322.

In step S323, the command execution availability determining unit 401 determines whether or not the user corresponding to the biometric data acquired in step S321 is permitted to execute the command specified by the user instructions received in step S322. If it is determined that the user is permitted, then the process proceeds to step S324. In step S324, the process execution unit 402 executes the process corresponding to the command specified by the user instructions received in step S322. Once the processing in step S324 ends, the command execution control process is terminated. In contrast, if it is determined in step S323 that the user is not permitted to execute the command specified by the user instructions received in step S322, then the command execution control process is terminated without executing that command.

In so doing, the controller 111 is able to easily control the execution of commands on a per-user basis. As a result, a user is able to easily execute the correct commands.

Herein, the execution control described above may be applied to all commands, or to just some commands.

Additionally, if the OS includes a mechanism for processing user privileges, then execution control may be conducted by using that mechanism. For example, the controller 111 may assign an OS group ID to each command, while also assigning an OS user ID to each set of biometric data. Each user may then be made to belong to all groups for commands that he or she is able to execute. In so doing, the OS can be used to classify respective users, and thus the command execution availability determining unit 401 is able to more easily determine command execution availability.

By using this function, an in-store display model can be easily configured as a limited functionality model, thereby making it easier to prevent vandalism of the display model, for example.

### 7. Seventh Embodiment

### [Remote Control]

Herein, a specified command may also be executed in an apparatus different from the apparatus where the command was specified. For example, given a television set and dedicated remote control, a command input using the remote control may be executed in the television set.

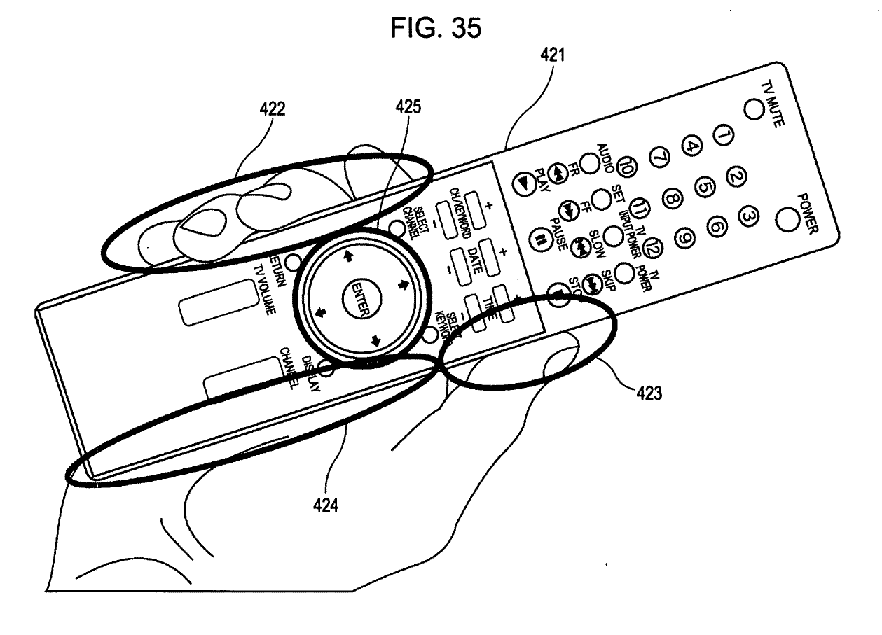

FIG. 35 is a diagram for explaining sensor installation positions. As shown in FIG. 35, the fingerprint detection window 201 of the fingerprint detector 126 may be provided on the chassis of a remote control 421 at a position ordinarily touched by a user's hand as he or she operates that remote control 421 (such as the positions indicated by the ellipses 422 to 425). In other words, the fingerprint detector 126 detects a user's fingerprint (i.e., biometric data) at a position ordinarily touched by the user's hand as he or she operates the remote control 421.

### [Determining Availability in the Remote Control]

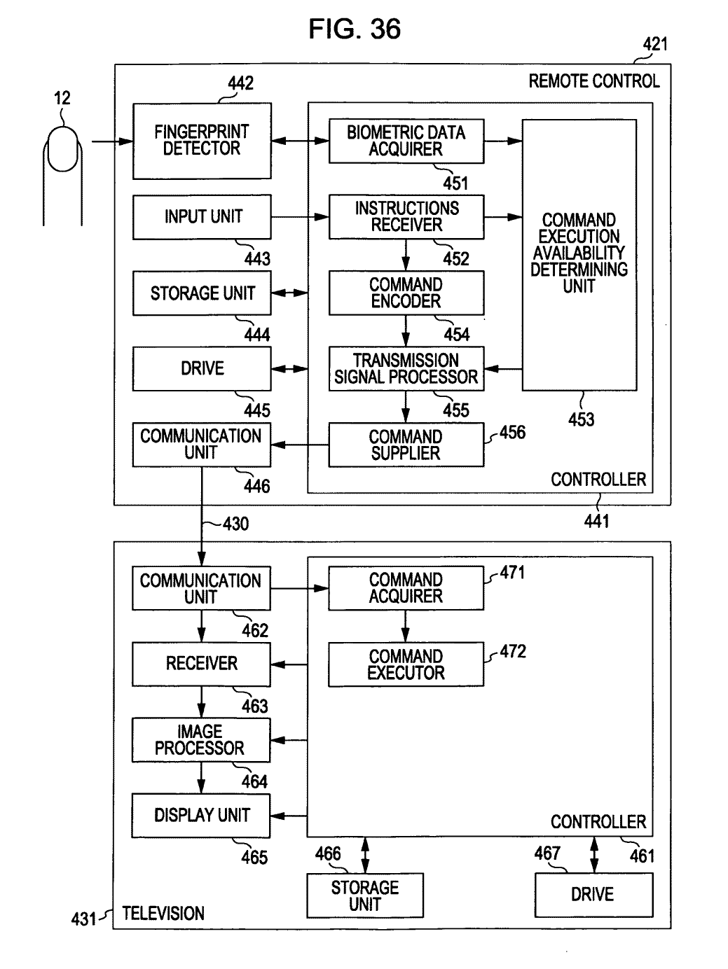

In a system having such a configuration, the determination of command execution availability may also be conducted at the remote control. FIG. 36 is a block diagram illustrating the primary configurations of controllers for respective devices in accordance with an embodiment of the present invention.

As shown in FIG. 36, the remote control 421 is a remote control for a television set 431, and receives user instructions with respect to the television set 431. The remote control 421 includes a controller 441, a fingerprint detector 442, an input unit 443, a storage unit 444, a drive 445, and a communication unit 446.

The fingerprint detector 442 corresponds to the fingerprint detector 126 described earlier. The fingerprint detector 442 is has a configuration basically similar to that of the fingerprint detector 126, and conducts similar processes. The input unit 443 corresponds to the input unit 131 described earlier. The input unit 443 has a configuration basically similar to that of the input unit 131, and conducts similar processes. The storage unit 444 corresponds to the storage unit 124 described earlier. The storage unit 444 has a configuration basically similar to that of the storage unit 124, and conducts similar processes. The drive 445 corresponds to the drive 134 described earlier. The drive 445 has a configuration basically similar to that of the drive 134, and conducts similar processes.

The communication unit 446 corresponds to the communication unit 133 described earlier. The communication unit 446 has a configuration basically similar to that of the communication unit 133, and communicates with a communication unit 462 in the television set 431 via a communication medium 430. Herein, the communication medium 430 may be a wired communication medium such as a transmission cable or network, or a wireless communication medium such as an over-the-air medium.

The controller 441 controls the various components of the remote control 421 and executes processing. Similarly to the controller 111 described earlier, the controller 441 includes components such as a CPU, ROM, and RAM, for example, and executes various processes for controlling the operation of the remote control 421.

The controller 441 includes the following function blocks: a biometric data acquirer 451, an instructions receiver 452, a command execution availability determining unit 453, a command encoder 454, a transmission signal processor 455, and a command supplier 456.

These function blocks are realized in the controller 441 as a result of a CPU loading and executing programs and data read from ROM into RAM, for example.

Similarly to the biometric data acquirer 241 described earlier, the biometric data acquirer 451 acquires biometric data (i.e., a fingerprint) detected in the fingerprint detector 126. Similarly to the instructions receiver 242 described earlier, the instructions receiver 452 receives user instructions input via the input unit 443.

Similarly to the command execution availability determining unit 401 described earlier, the command execution availability determining unit 453 references information such as the table information 411 shown in FIG. 33, for example, and determines whether or not the user corresponding to biometric data acquired by the biometric data acquirer 451 is permitted to execute a command specified by user instructions received by the instructions receiver 452.

The command encoder 454 encodes a command specified by user instructions received by the instructions receiver 452. If execution of the command is permitted by the command execution availability determining unit 453, then the transmission signal processor 455 embeds the command encoded by the command encoder 454 into a transmission signal. The command supplier 456 supplies the signal with the command embedded by the transmission signal processor 455 to the television set 431 via the communication unit 446.

The television set 431 in FIG. 36 is controlled on the basis of a control signal supplied by the remote control 421 to receive a television signal broadcast by a broadcasting station, and then display the images thereof. The television set 431 may include, for example, a controller 461, a communication unit 462, a receiver 463, an image processor 464, a display unit 465, a storage unit 466, and a drive 467.

The communication unit 462 corresponds to the communication unit 133 described earlier. The communication unit 462 has a configuration basically similar to that of the communication unit 133, and communicates with the communication unit 446 of the remote control 421 via the communication medium 430.

The receiver 463 receives a broadcast wave of the television signal supplied by the broadcasting station or other provider, and obtains the broadcast television signal. The image processor 464 processes the television signal received at the receiver 463. The display unit 465 corresponds to the display unit 125 described earlier. The display unit 465 has a configuration basically similar to that of the display unit 125, and displays images processed by the image processor 464 as well as images or other information supplied by the controller 461, for example.

The storage unit 466 corresponds to the storage unit 124 described earlier. The storage unit 466 has a configuration basically similar to that of the storage unit 124, and conducts similar processes to store information. The drive 467 corresponds to the drive 134 described earlier. The drive 467 has a configuration basically similar to that of the drive 134, and conducts similar processes.

The controller 461 controls the various components of the television set 431 and executes processing. Similarly to the controller 111 described earlier, the controller 461 includes components such as a CPU, ROM, and RAM, for example, and executes various processes for controlling the operation of the television set 431.

The controller 461 includes the following function blocks: a command acquirer 471, and a command executor 472. These function blocks are realized in the controller 461 as a result of a CPU loading and executing programs and data read from ROM into RAM, for example.

The command acquirer 471 acquires a command supplied by the remote control 421 via the communication unit 462. The command executor 472 executes a command acquired by the command acquirer 471.

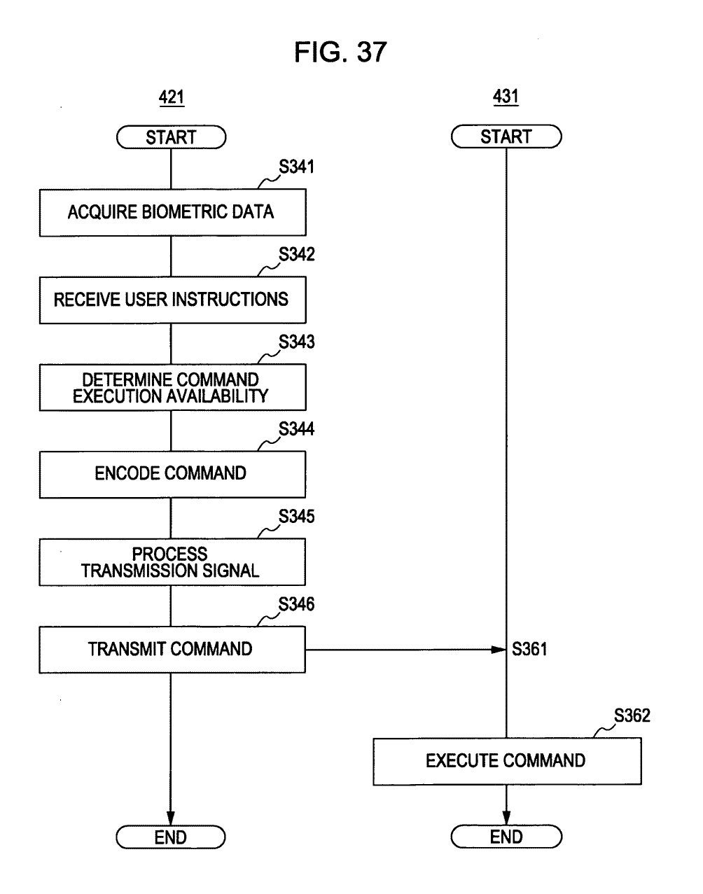

The flow of a command execution process executed in a system configured as above and in accordance with an embodiment of the present invention will now be described with reference to the flowchart shown in FIG. 37.

In step S341, the biometric data acquirer 451 of the remote control 421 controls the fingerprint detector 442 to acquire biometric data (such as a fingerprint of the finger 12) for the user operating the remote control 421. In step S342, the instructions receiver 452 receives user instructions input via the input unit 443.

In step S343, the command execution availability determining unit 453 determines whether or not execution of the command specified by the user instructions received in step S342 is available for the user corresponding to the biometric data acquired in step S341. In step S344, the command encoder 454 encodes the command. If it is determined that the command is executable, then in step S345, the transmission signal processor 455 processes a transmission signal, and embeds the encoded command into the signal. In step 346, the command supplier 456 sends the transmission signal with the embedded command to the television set 431 via the communication unit 446.

In step S361, the command acquirer 471 of the television set 431 causes the communication unit 462 to receive the transmission signal supplied by the remote control 421, and acquires the command contained in the transmission signal. In step S362, the command executor 472 executes the command acquired in step S361.

Herein, if it is determined by the processing in step S343 that the command is not executable, then transmission of the command is aborted.

In so doing, the remote control 421 is able to conduct a command transmission control, such that only commands that are permitted with respect to the user operating the remote control 421 itself are made to be executed by the television set 431.

For example, it is possible to conduct command execution control on a per-user basis such that only Father or Mother can change the channel, for example. By using biometric data in such a control, the controller 441 is able to more easily make use of the command execution availability settings.

### [Determining Availability in the Television Set ]

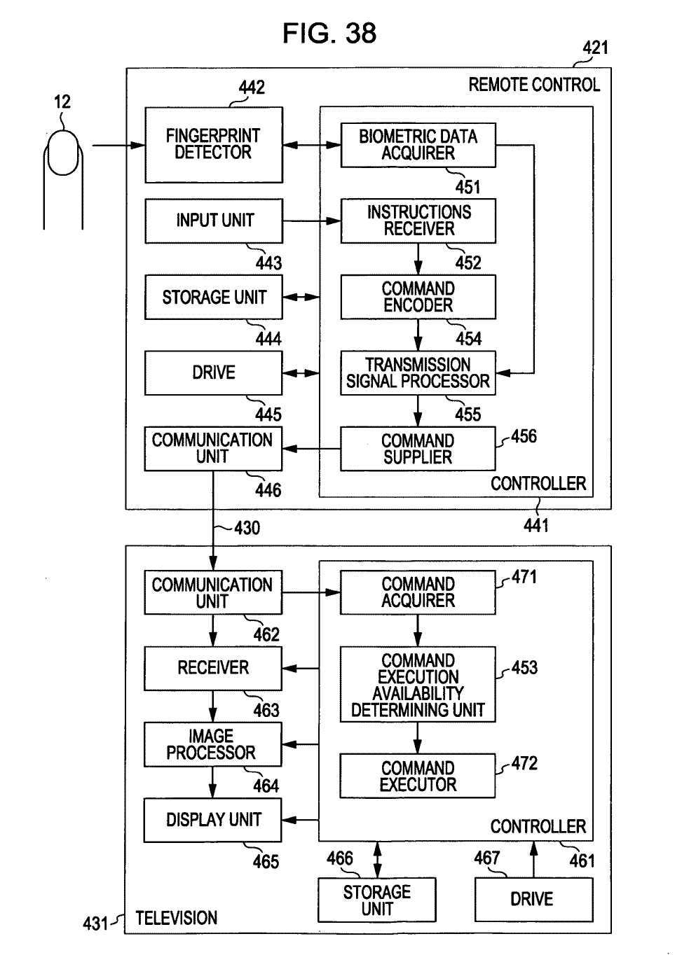

Herein, the determination of command execution availability may also be conducted at the receiving television set 431. The primary configurations of the controllers for each device in accordance with an embodiment of the present invention for this case are shown in FIG. 38.

As shown in FIG. 38 the controller 441 in this case does not include the command execution availability determining unit 453 included in the controller 441 shown in FIG. 36. Instead, the controller 461 includes the command execution availability determining unit 453. In other words, the determination of command execution availability is executed by the television set 431 (more specifically, the controller 461), rather than the remote control 421 (more specifically, the controller 441).

Besides the command execution availability determining unit 453, the configuration is basically similar to that shown in FIG. 36. However, in this case, the transmission signal processor 455 of the controller 441 embeds both the command encoded by the command encoder 454 as well as the biometric data acquired by the biometric data acquirer 451 into a transmission signal. The command supplier 456 then supplies the transmission signal containing the encoded command and the biometric data to the television set 431 via the communication unit 446.

The command acquirer 471 of the controller 461 receives the transmission signal via the communication unit 462, and acquires the command and biometric data. The command execution availability determining unit 453 determines whether or not the user corresponding to the biometric data acquired by the command acquirer 471 is able to execute the command acquired by the command acquirer 471. If the command is executable, then the command executor 472 executes the command.

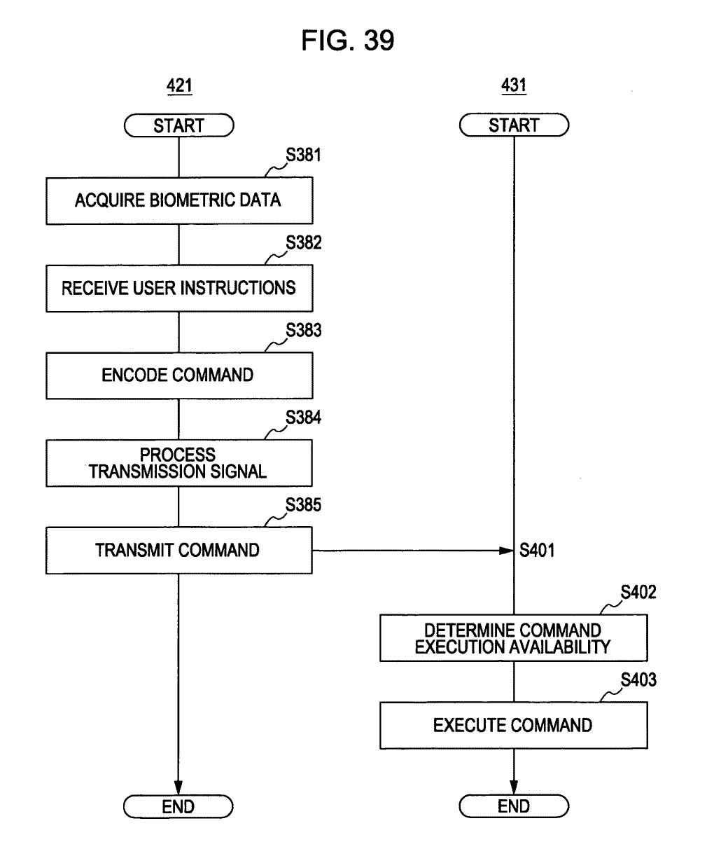

The flow of such a command execution process in a system configured as shown in FIG. 38 and in accordance with an embodiment of the present invention will now be described with reference to the flowchart shown in FIG. 39.

In step S381, the biometric data acquirer 451 of the remote control 421 controls the fingerprint detector 442 to acquire biometric data (such as a fingerprint of the finger 12) for the user operating the remote control 421. In step S382, the instructions receiver 452 receives user instructions input via the input unit 443.

In step S383, the command encoder 454 encodes the command specified by the user instructions received in step S382. In step S384, the transmission signal processor 455 processes a transmission signal, embedding both the command encoded in step S383 as well as the biometric data acquired in step S381 into the signal. In step S385, the command supplier 456 sends the transmission signal that was embedded with the command and biometric data in step S384 to the television set 431 via the communication unit 446.

In step S401, the command acquirer 471 of the television set 431 causes the communication unit 462 to receive the transmission signal supplied by the remote control 421, and acquires the command and biometric data contained in the transmission signal.

In step S402, the command execution availability determining unit 453 determines whether or not execution of the command acquired in step S401 is available for the user corresponding to the biometric data acquired in step S401. If it is determined that the command is executable, then in step S403 the command executor 472 executes the command acquired in step S401.

Herein, if it is determined by the processing in step S402 that the command is not executable, then execution of the command is aborted.

In this way, it is possible to cause the determination of command execution availability to be executed at the receiving television set 431. In so doing, the load on the remote control 421 can be decrease. However, the load on the television set 431 increases by an equivalent degree. Although arbitrary, the decision of whether to determine command execution availability on the transmitting end or the receiving end is preferably made according to the capability of each device.

The foregoing describes a system made up of a television set 431, as well as a remote control 421 that controls the television set 431. However, determination of command execution availability as described above is applicable to any system that sends and receives commands. For example, the receiving device may also be a recorder, home stereo, video game console, lighting, air conditioner or heater, or similar apparatus. Obviously, apparatus other than the above are also possible. As another example, the system may also be made up of two or more personal computers connected via a network, or a system made up of a server and client connected via a network.

As described above, a user's biometric information and instructions are received, and the user's biometric information is associated with information obtained by the instructions as control information for that information. In so doing, a shooting apparatus 100 or remote control 421 is able to improve the user-friendliness of information, and more easily make use of such information.

In particular, by associating a user's biometric data (i.e., user data or similar data) to settings data for the apparatus, the shooting apparatus 100 is able to more easily provide a user's desired settings to that user. In addition, by using the biometric data to read out settings data, it also becomes easy perform processes such as updating, adding, or deleting settings data. Moreover, by managing the biometric data as user data that is separate from the settings data, and then associating the settings data to the user data, processes such as updating, adding, and deleting just specific parts of the information becomes easy. Also, since the user data of another user can be easily duplicated, a user is able to easily register another user's settings in his or her own user data.

Furthermore, by associating biometric data (or alternatively, user data associated with the biometric data) with commands, a shooting apparatus 100 or remote control 421 is able to configure command execution availability settings for each user. In so doing, a shooting apparatus 100 or remote control 421 is not only able to simply prevent the execution of irrelevant commands by some users, but is also able to adjust the display of a GUI on a per-user basis in the case where, for example, a GUI is used to present executable commands to users.

For example, a shooting apparatus 100 or remote control 421 is able to prohibit operation (i.e., prevent input) of GUI buttons or other elements whereby a user would specify a non-executable command. A shooting apparatus 100 or remote control 421 is also able to change factors such as the color, brightness, or design of those GUI buttons or other elements to indicate to a user that input is prohibited. Moreover, a shooting apparatus 100 or remote control 421 is also able to not display the GUI buttons or other elements whereby a user would specify a non-executable command, for example. A shooting apparatus 100 or remote control 421 may then modify the layout by enlarging the other GUI buttons or other elements to match the space left by the non-displayed elements, and thereby make input easier for the user, for example.

In so doing, accidental command execution is suppressed, and a user is able easily operate the apparatus, and thus the safety and security of the apparatus can be improved. For example, it is possible to use the above as a child lock or similar function, wherein operation is prohibited for specific users, such as children. As another example, it is possible to use the above as a login password function, wherein biometric data is used at command execution for simple user authentication, and wherein irrelevant operation of the apparatus by other persons is suppressed when the apparatus is lost, for example. As another example, by restricting the executable commands such that, for example, only information input is permitted for one user and only information output is permitted for another user, information transfer control via the apparatus is also possible.

As a result of a shooting apparatus 100 or remote control 421 using the biometric data of users, such controls can be easily realized.

The foregoing series of process may be executed by means or hardware or software. In the case where the foregoing series of processes is executed by means of software, a program constituting such software is installed from a network or recording medium.

As shown by way of example in FIG. 1, the recording medium may be a removable medium 141 that stores the program and is separate from the main body of the apparatus, being distributed in order to deliver the program to the administrator of the shooting apparatus 100 (or the remote control 421 or television set 431). Alternatively, the recording medium may be a component delivered to the administrator already built into the apparatus itself, such as the ROM in the controller 111, or a hard disk included in the storage unit 124.

The program may also be provided via a wired or wireless transmission medium, such as a local area network, the Internet, or a digital satellite broadcast. In this case, the program is received by the communication unit 133 via the wired or wireless transmission medium, and then installed to the storage unit 124 or other component.

Herein, the program executed by a computer may be a program whereby processes are conducted in a time series following the order described in the present specification. However, the program may also be stated such that processes are conducted in parallel or at appropriate timings, such as when called.

Moreover, in the present specification, the steps stated in the program recorded to the recording medium are obviously taken to include processes conducted in a time series following the order described herein, but may also include processes executed in parallel or individually without being processed in a strict time series.

Also, in the present specification, the term “system” is taken to mean the entirety of an apparatus made up of a plurality of apparatus, means, or similar components.

It should be appreciated that the configurations described as single apparatus (or processors) in the foregoing may also be divided and configured as a plurality of apparatus (or processors). Likewise, the configurations described as a plurality of apparatus (or processors) in the foregoing may also be integrated and configured as a single apparatus (or processor). In addition, further aspects of the configuration other than that described in the foregoing may of course also be added to respective apparatus. Furthermore, a portion of the configuration of a particular apparatus (or processor) may also be included in the configuration of another apparatus (or processor), as long as the overall configuration and operation of the system as a whole is essentially the same. Thus it should be understood that embodiments of the present invention are not limited to the embodiments described in the foregoing, and that various modifications are possible without departing from the spirit and scope of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
acquiring means for acquiring a user's biometric information;
receiving means for receiving instructions from the user; and
associating means for associating the biometric information with information obtained on the basis of the instructions.

2. The information processing apparatus according to claim 1, wherein
the information is settings information for the information processing apparatus, and generated on the basis of the instructions.

3. The information processing apparatus according to claim 1, wherein
the information is user data for the user, and registered in the information processing apparatus on the basis of the instructions.

4. The information processing apparatus according to claim 3, wherein
settings information for the information processing apparatus is associated with the user data.

5. The information processing apparatus according to claim 1, further comprising:
duplicating means for duplicating another user's user data, and changing the other user's identification information that is contained in the user data to the user's identification information, on the basis of the instructions;
wherein
the associating means replaces identification information for the other user's biometric information contained in the user data with identification information for the user's biometric information.

6. The information processing apparatus according to claim 1, wherein
the information is execution availability settings for a command whose execution is specified by the instructions.

7. The information processing apparatus according to claim 1, wherein
the information is content generated on the basis of the instructions.

8. The information processing apparatus according to claim 7, wherein
the associating means associates the biometric information with the content as usage permission settings for the content.

9. The information processing apparatus according to claim 7, wherein
the associating means associates the biometric information with the content as information indicating the creator of the content.

10. The information processing apparatus according to claim 1, wherein
the acquiring means is provided at a place on the chassis of the information processing apparatus that is easily touched by the user's fingers, and wherein the acquiring means acquires biometric information in the form of the user's fingerprint.

11. An information processing method, comprising the steps of:
acquiring a user's biometric information;
receiving instructions from the user; and
associating the acquired biometric information with information obtained on the basis of the received instructions.

12. A program causing a computer to execute an information processing method, the method comprising the steps of:
acquiring a user's biometric information;
receiving instructions from the user; and
associating the acquired biometric information with information obtained on the basis of the received instructions.

13. An information processing apparatus, comprising:
a biometric information acquirer configured to acquire a user's biometric information;
an instructions receiver configured to receive instructions from the user; and
an associating unit configured to associate the biometric information with information obtained on the basis of the instructions.
